(19) United States
(12) Patent Application Publication
(10) Pub. No.: US 2015/0170536 A1
(43) Pub. Date: Jun. 18, 2015

(54) Time-Varying Learning and Content Analytics Via Sparse Factor Analysis

(71) Applicant: WILLIAM MARSH RICE UNIVERSITY, Houston, TX (US)

(72) Inventors: Shiting Lan, Houston, TX (US); Christoph E. Studer, Houston, TX (US); Richard G. Baraniuk, Houston, TX (US)

(21) Appl. No.: 14/575,344

(22) Filed: Dec. 18, 2014

Related U.S. Application Data
(60) Provisional application No. 61/917,856, filed on Dec. 18, 2013.

(51) Int. Cl. G09B 5/12; G06N 99/00; G09B 7/00

(52) U.S. Cl. CPC G09B 5/12; G09B 7/00; G06N 99/005

(57) ABSTRACT

A mechanism is disclosed for tracing variation of concept knowledge of learners over time and evaluating content organization of learning resources used by the learners. Computational iterations are performed until a termination condition is achieved. Each of the computational iterations includes a message passing process and a parameter estimation process. The message passing process includes computing a sequence of probability distributions representing time evolution of concept knowledge of the learners for a set of concepts based on (a) learner response data acquired over time, (b) state transition parameters modeling transitions in concept knowledge resulting from interaction with the learning resources, (c) question-related parameters characterizing difficulty of the questions and strengths of association between the questions and the concepts. The parameter estimation process computes an update for parameter data including the state transition parameters and the question-related parameters based on the sequence of probability distributions and the learner response data.

### PRIORITY CLAIM DATA

This application claims the benefit of priority to U.S. Provisional Application No. 61/917,856, filed Dec. 18, 2013, titled “Time-Varying Learning and Content Analytics via Sparse Factor Analysis”, invented by shiing Lan, Christoph E. Studer and Richard G. Baraniuk, which is hereby incorporated by reference in its entirety as though fully and completely set forth herein.

### GOVERNMENT RIGHTS IN INVENTION

This invention was made with government support under Grant Number DMS-0931945 awarded by the National Science Foundation. The government has certain rights in the invention.

### FIELD OF THE INVENTION

The present invention relates to the field of machine learning, and more particularly, to mechanisms for tracking the concept knowledge of learners as the learners interact with learning resources and answer questions over time, and for estimating the quality, difficulty and organization of the learning resources.

### DESCRIPTION OF THE RELATED ART

The recently developed sparse factor analysis (SPARFA) framework (Lan et al. (2014)) comprises a novel statistical model and factor analysis algorithms for machine learning-based learning analytics (LA) and content analytics (CA). SPARFA can be viewed as an extension to multidimensional item response theory (MIRT) and cognitive dynamic models (CDM). In contrast to MIRT and CDM, however, SPARFA focuses on the interpretability of the estimated model parameters.

While powerful, the SPARFA framework has two important limitations. First, it assumes that the learners' concept knowledge states remain constant over time. This complicates its application in real learning scenarios, where learners learn (and forget) concepts over time (weeks, months, years, decades). Second, SPARFA models only the learners' interactions with questions, which measure concept knowledge, and not other kinds of learning opportunities, such as reading a textbook, viewing a lecture, or conducting a laboratory or Gedanken experiment. This complicates its application in automatically recommending new resources to individual learners for remedial or enrichment studies.

Thus, there exists a need for a personalized learning system (PLSs) capable of providing at least one of the following components:

(A) Under the heading of learning analytics (LA), estimate each learner's knowledge state and dynamically trace its changes over time, as they either learn by interacting with various learning resources (e.g., textbook sections, lecture videos, labs) and questions (e.g., in quizzes, homework assignments, exams, and other assessments), or forget.

(B) Under the heading of content analytics (CA), provide insight on the quality, difficulty, and organization of the learning resources and questions.

### SUMMARY

We disclose SPARFA-Trace, a new machine learning-based framework for time-varying learning and content analytics for education applications. We develop a novel message passing-based, blind, approximate Kalman filter for sparse factor analysis (SPARFA) that jointly traces learner concept knowledge over time, analyzes learner concept knowledge state transitions (induced by interacting with learning resources, such as textbook sections, lecture videos, etc., or the forgetting effect), and estimates the content organization and difficulty of the questions in assessments. These quantities may be estimated solely from binary-valued (correct/incorrect) graded learner response data and the specific actions each learner performs (e.g., answering a question or studying a learning resource) at each time instant.

In one set of embodiments, a computer-implemented method may be employed for tracing variation of concept knowledge of learners over time and evaluating content organization of learning resources used by the learners. The method may include performing a number of computational iterations until a termination condition is achieved, wherein each of the computational iterations includes a message passing process and a parameter estimation process.

The message passing process may include computing a sequence of probability distributions representing time evolution of concept knowledge of the learners for a set of concepts based on (a) learner response data graded answers to questions posed to the learners acquired over time, (b) state transition parameters modeling transitions in concept knowledge resulting from interaction with the learning resources, (c) question-related parameters characterizing difficulty of the questions and strengths of association between the questions and the concepts.

The parameter estimation process may compute an update for parameter data including the state transition parameters and the question-related parameters based on the sequence of probability distributions and the learner response datagraded answers.

The method may also include storing the sequence of probability distributions and the update for the parameter data in memory.

Additional embodiments are described in U.S. Provisional Application No. 61/917,856, filed Dec. 18, 2013.

### BRIEF DESCRIPTION OF THE DRAWINGS

A better understanding of the present invention can be obtained when the following detailed description of the preferred embodiments is considered in conjunction with the following drawings.

FIG. 1A illustrates one embodiment of a client-server based architecture for providing personalized learning services to users (e.g., online users).

FIG. 1B illustrates one embodiment of the SPARFA-Trace framework, which processes the binary-valued graded learner response matrix Y (binary-valued, with 1 denoting a correct response, 0 an incorrect one, and ? indicates an unobserved one) and the learner activity matrices {R^{(t)}} (binary-valued, with 1 denoting that a learner studied a particular learning resource, and 0 otherwise). Upon analyzing this data, SPARFA-Trace jointly traces the learner concept knowledge states cⱼ^{(t)} (a happy face represents high concept knowledge, a neutral face represents medium concept knowledge, and a sad face represents low concept knowledge) over time, and estimates the learning resource content organization and quality parameters Dₘ, dₘ, and Γₘ, together with question-concept association parameters wᵢ and question difficulty parameters μᵢ.

FIG. 2 illustrates one embodiment of a factor graph message passing algorithm for the estimation of a set of T latent state variables with Markovian transition properties from (possibly noisy) observations.

FIGS. 3A and 3B illustrate the accuracy of latent concept knowledge state and learning resource parameters and question-dependent parameters estimation for synthetic data, according to one embodiment. FIG. 3A illustrates learner concept knowledge state estimation error versus time instance t for different percentages of observed responses. FIG. 3B illustrates learning resource parameter estimation error for various number of learners N. Note the general trend that all considered performance measures improve as the amount of observed data increases.

FIGS. 4A and 4B illustrate, according to one embodiment, estimated latent learner concept knowledge states for all time instances and for a first dataset. FIG. 4A illustrates latent concept knowledge state evolution for a first learner. FIG. 4B illustrates average learner latent concept knowledge states evolution.

FIGS. 5A and 5B visualize, according to one embodiment, learner knowledge state transition effect of two distinct learning resources for a second dataset. FIG. 5A illustrates learner knowledge state transition effect for Learning resource 3. FIG. 5B illustrates learner knowledge state transition effect for Learning resource 9.

FIG. 6A is an example of a question-concept association graph with concept labels.

FIG. 6B is a table showing the label for each concept referenced in FIG. 6A.

FIG. 7 illustrates one method for tracing variation of concept knowledge of learners over time and evaluating content organization of learning resources used by the learners.

FIG. 8 illustrates another embodiment for tracing variation of concept knowledge of learners over time and evaluating content organization of learning resources used by the learners.

FIG. 9 illustrates one embodiment of a computer system that may be used to implement any of the embodiments described herein.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Incorporations by Reference

The following documents are hereby incorporated by reference in their entireties as though fully and completely set forth herein:
U.S. Provisional Application No. 61/840,853, filed Jun. 28, 2013, entitled “Test Size Reduction for Concept Estimation”, invented by Divyanshu Vats, Christoph E. Studer and Richard G. Baraniuk;
U.S. patent application Ser. No. 14/214,835, filed Mar. 15, 2014, entitled “Sparse Factor Analysis for Learning Analytics and Content Analytics”, invented by Baraniuk, Lan, Studer and Waters;
U.S. Provisional Application 61/790,727, filed Mar. 15, 2013, entitled “Sparse Factor Analysis for Learning Analytics and Content Analytics”, invented by Baraniuk, Lan, Studer and Waters.

### TERMINOLOGY

A memory medium is a non-transitory medium configured for the storage and retrieval of information. Examples of memory media include: various kinds of semiconductor-based memory such as RAM and ROM; various kinds of magnetic media such as magnetic disk, tape, strip and film; various kinds of optical media such as CD-ROM and DVD-ROM; various media based on the storage of electrical charge and/or any of a wide variety of other physical quantities; media fabricated using various lithographic techniques; etc. The term “memory medium” includes within its scope of meaning the possibility that a given memory medium might be a union of two or more memory media that reside at different locations, e.g., in different portions of an integrated circuit or on different integrated circuits in an electronic system or on different computers in a computer network.

A computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

A computer system is any device (or combination of devices) having at least one processor that is configured to execute program instructions stored on a memory medium. Examples of computer systems include personal computers (PCs), laptop computers, tablet computers, mainframe computers, workstations, server computers, client computers, network or Internet appliances, hand-held devices, mobile devices such as media players or mobile phones, personal digital assistants (PDAs), computer-based television systems, grid computing systems, wearable computers, computers in personalized learning systems, computers implanted in living organisms, computers embedded in head-mounted displays, computers embedded in sensors forming a distributed network, computers embedded in a camera devices or imaging devices or measurement devices, etc.

A programmable hardware element (PHE) is a hardware device that includes multiple programmable function blocks connected via a system of programmable interconnects. Examples of PHEs include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores).

In some embodiments, a computer system may be configured to include a processor (or a set of processors) and a memory medium, where the memory medium stores program instructions, where the processor is configured to read and execute the program instructions stored in the memory medium, where the program instructions are executable by the processor to implement a method, e.g., any of the various method embodiments described herein, or, any combination of the method embodiments described herein, or, any subset of any of the method embodiments described herein, or, any combination of such subsets.

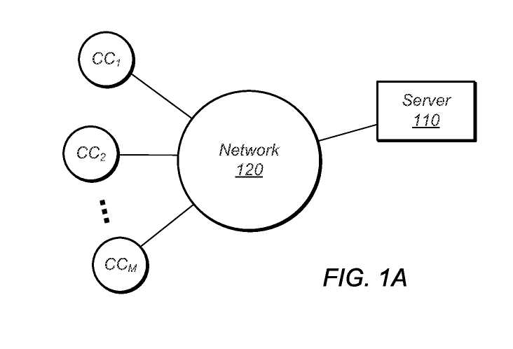

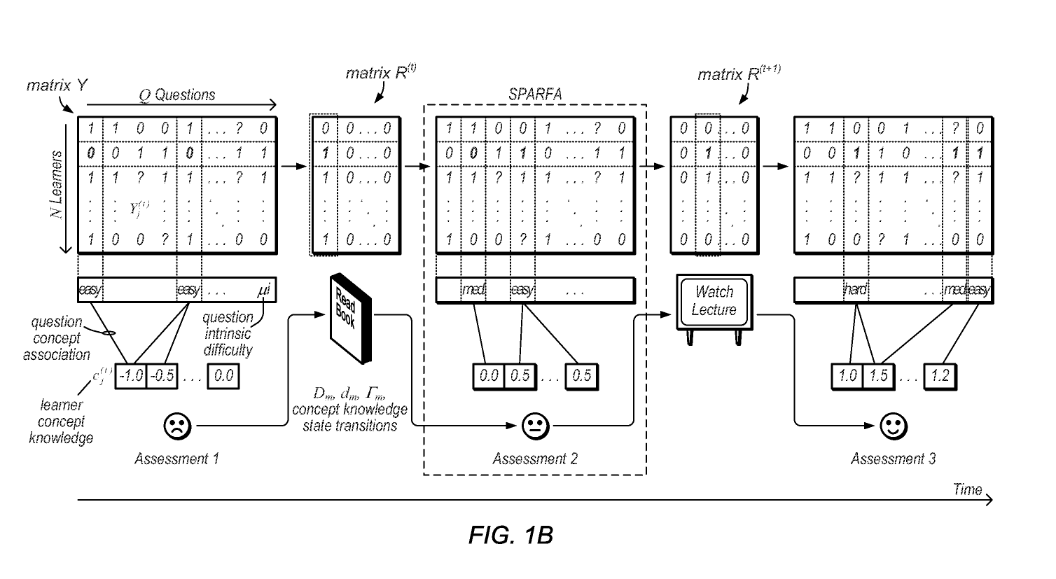

In one set of embodiments, a learning system may include a server 110 (e.g., a server controlled by a learning service provider) as shown in FIG. 1A. The server may be configured to perform any of the various methods described herein. Client computers CC₁, CC₂, . . . , CC_{M} may access the server via a network 120 (e.g., the Internet or any other computer network). The persons operating the client computers may include learners, instructors, graders, the authors of questions, the authors of learning resources, etc.

The learners may use client computers to access and interact with learning resources provided by the server 110, e.g., learning resources such as text material, videos, lab exercises, live communication with a tutor or instructor, etc.

The learners may use client computers to access questions from the server and provide answers to the questions, e.g., as part of a test or quiz or assessment. The server may grade the learner-provided answers automatically based on correct answers previously provided, e.g., by instructors or the authors of the questions. (Of course, an instructor and a question author may be one and the same person in some situations.) Alternatively, the server may allow an instructor or other authorized person to access the answers that have been provided by learners. An instructor (e.g., using a client computer) may assign grades to the answers, and invoke execution of one or more of the computational methods described herein.

It should be noted that questions and learning resources are not necessarily disjoint categories. For example, in some embodiments, a question may serve as a learning resource, especially when the answer to the question is made available to the learner after his/her attempt to answer the question.

Furthermore, the server 110 may employ any of the presently disclosed methods to (a) estimate the time evolution of concept knowledge for one or more learners as they interact with learning resources and answer questions over time and (b) estimate the quality and organization of the learning resources. To facilitate such methods, the server 110 may maintain a historical record of the learning resources used by each learner, and a historical record of the questions answer by each learner. For example, the server may: store the questions answered by each learner in each of a sequence of tests; and store identifiers that identify the one or more learning resources the learner interacted with between each successive pair of assessments.

Yet further, a learner may access the server to view the estimated time evolution of his/her concept-knowledge for one or more concepts, and/or, to view a graphical depiction of question-concept relationships determined by the server, and/or, to receive recommendations on learning resources for further study or questions for further study.

In some embodiments, instructors or other authorized persons may access the server to perform one or more tasks such as: selecting questions from a database of questions, e.g., selecting questions for a new test to be administered for a given set of concepts; assigning tags to questions (e.g., assigning one or more character strings that identify the one or more concepts associated with each questions); drafting new questions; editing currently-existing questions; drafting or editing the text for answers to questions; drafting or editing the feedback text for questions; viewing a graphical depiction of question-concept relationships; viewing the estimates time evolution of concept knowledge (e.g., a graphical illustration thereof) for one or more selected learners; invoking and viewing the results of statistical analysis of the concept-knowledge values of a set of learners, e.g., viewing histograms of concept knowledge over the set of learners; sending and receiving messages to/from learners; uploading video and/or audio lectures (or more generally, educational content) for storage and access by the learners.

In another set of embodiments, a person (e.g., an instructor) may execute one or more of the presently-disclosed computational methods on a stand-alone computer, e.g., on his/her personal computer or laptop. Thus, the computational method(s) need not be executed in a client-server environment.

### Time-Varying Learning and Content Analytics Via Sparse Factor Analysis

### 1. Introduction

The traditional “one-size-fits-all” approach to education is a major bottleneck to improving learning outcomes worldwide. Fortunately, over the last few decades, significant progress has been made on new technologies that provide timely feedback to learners as they follow personalized learning pathways through nonlinearly interconnected learning content. Increasingly, these technologies are based on machine learning algorithms that automatically mine data from a potentially large number of learner interactions. See VanLehn et al. (2005); Knewton (2012), for examples.

In our view, a modern personalized learning system (PLS) may include one or both of the following components.

(A) In the category of learning analytics (LA), the PLS may estimate each learner's knowledge state and dynamically trace its changes over time, as they either learn by interacting with various learning resources (e.g., textbook sections, lecture videos, labs) and questions (e.g., in quizzes, homework assignments, exams, and other assessments), or forget (see Weiner and Reed (1969)).

(B) In the category of content analytics (CA), the PLS may provide insight on the quality, difficulty, and organization of the learning resources and questions.

### 1.1. Sparse Factor Analysis for Learning and Content Analytics

The recently developed sparse factor analysis (SPARFA) framework (Lan et al. (2014)) comprises a novel statistical model and factor analysis algorithm (Linting et al. (2007); Chow et al. (2011a)) for machine learning-based LA and CA. SPARFA can be viewed as an extension to multidimensional item response theory (MIRT) (Ackerman (1994); Forero and Maydeu-Olivares (2009); Ip and Chen (2012); Stevenson et al. (2013)) and cognitive dynamic models (CDM) (Templin and Henson (2006)). In contrast to MIRT and CDM, however, SPARFA focuses on the interpretability of the estimated model parameters.

In the SPARFA model, a learner's correct/incorrect responses to a collection of questions are governed by three factors: (i) the relationships between the questions and a small set of latent concepts, (ii) the learner's knowledge of the concepts, and (iii) the intrinsic difficulty of the questions. More specifically, the binary-valued graded response of learner j to question is assumed to be a Bernoulli random variable (with 1 representing a correct answer and 0 an incorrect one) Y_{i,j}, and we have

Y_{i,j}˜Ber(Φ(Z_{i,j})) with Z_{i,j}=wᵢ^{T}cⱼ−μᵢ,

Here, Z_{i,j} is a slack variable governing the probability of learner j answering question i correctly or incorrectly, and Φ(•) is the inverse logit/probit link function. The variable Z_{i,j} depends on three factors: (i) the question-concept association vector wᵢ which characterizes how question i relates to each abstract concept, (ii) the learner concept knowledge vector cⱼ of learner j, and (iii) the intrinsic difficulty parameter μᵢ of question i. The question-concept association matrix W, which is obtained by stacking the column vectors wᵢ, iε{1, 2, . . . , }, can be interpreted as a real-valued variant of the Q-matrix (Barnes (2005); Rupp and Templin (2008)). The learner concept knowledge matrix C and intrinsic difficulty vector μ are formed similarly. With these definitions, we have the streamlined notation

Y˜Ber(Φ(Z)) with Z=WC−μ,

where the inverse link function operates entry-wise on the matrix Z. Given the graded learner response data Y, the SPARFA framework jointly estimates C to effect LA and W and μ to effect CA. Both maximum likelihood and Bayesian estimation techniques have been developed; see Lan et al. (2014) for more details.

While powerful, the SPARFA framework has two important limitations. First, it assumes that the learners' concept knowledge states remain constant over time. This complicates its application in real learning scenarios, where learners learn (and forget) concepts over time (weeks, months, years, decades) (Carrier and Pashler (1992); Millsap and Meredith (1988); Codd and Cudeck (2013)). Second, SPARFA models only the learners' interactions with questions, which measure concept knowledge states, and not other kinds of learning opportunities, such as reading a textbook, viewing a lecture, or conducting a laboratory or Gedankenexperiment. This complicates its application in automatically recommending new resources to individual learners for remedial or enrichment studies.

### 1.2. SPARFA-Trace: Time-Varying Learning and Content Analytics

In this patent disclosure, we extend the SPARFA framework to address these limitations. We develop SPARFA-Trace, an on-line estimation algorithm that jointly performs time-varying LA and CA. The core machinery is based on blind approximate Kalman filtering, which makes SPARFA-Trace more computationally efficient than the dynamic factor analysis algorithm (Chow et al. (2011b)) and the dynamic latent trait model (Dunson (2003)).

The main working principles of SPARFA-Trace are illustrated in FIG. 1B. Time-varying LA may be performed by tracing (tracking) the evolution of each learner's concept knowledge state vector cⱼ^{(t)} over time t, based on observed binary-valued (correct/incorrect) graded learner responses to questions matrix Y and on the learner activity matrices R^{(t)}. CA may be performed by estimating the learner concept knowledge state transition parameters Dₘ, dₘ, Γₘ, the question-concept associations wᵢ, and the question intrinsic difficulties μᵢ based on the estimated learner concept knowledge states at all time instances.

Tracing the learners' concept knowledge states over time is complicated by the fact that the observations are noisy, binary-valued graded learner responses to questions. Furthermore, the underlying state-transition and observation parameters are, in general, unknown in real educational scenarios. To perform this on-line estimation, we develop a novel message passing-based algorithm that employs an elegant approximation (based on a novel convex optimization and expectation-maximization framework) that enables us to apply an approximate Kalman filter (Kalman (1960)).

To test and validate the effectiveness of SPARFA-Trace, we conduct a series of validation experiments using synthetic educational datasets as well as real-world educational datasets collected with OpenStax Tutor (OpenStaxTutor (2013), Butler et al. (2014)). We show that SPARFA-Trace can accurately trace learner concept knowledge, estimate learner concept knowledge state transition parameters, and estimate the question-dependent parameters. Furthermore, we show that it achieves comparable or better performance than existing approaches on predicting unobserved learner responses.

### 1.3. Related Work in Knowledge Tracing

The closest related work to SPARFA-Trace is knowledge tracing (KT), a popular technique for tracing learner knowledge evolution over time and for predicting future learner performance (see, e.g., Corbett and Anderson (1994); Pardos and Heffernan (2010)). Powerful as it is, KT suffers from three key drawbacks. First, KT uses binary learner knowledge state representations, characterizing learners as to whether they have mastered a certain concept (or skill) or not. The limited explanatory power of binary concept knowledge state representations prohibits the design of more powerful and sophisticated LA and CA algorithms. Second, KT assumes that each question is associated with exactly one concept. This restriction limits KT to very narrow educational domains and prevents it from generalizing to typical courses/assessments involving multiple concepts. Third, KT uses a single “probability of learning” parameter to characterize the learner knowledge state transitions over time and assumes that a concept cannot be forgotten once it is mastered. This limits KT's ability to perform accurate CA, i.e., analyze the quality and organization of different learning resources that lead to different learner knowledge state transitions. See Section 6 below for a detailed comparison of SPARFA-Trace with previous work in KT and other machine learning-based approaches to personalized learning

### 2. Statistical Model for Time-Varying Learning and Content Analytics

We start by extending the SPARFA statistical model (Lan et al. (2014)) to trace learner concept knowledge over time in Section 2.1. In Section 2.2, we characterize the transition of a learner's concept knowledge states between consecutive time instances as an affine model, which is parameterized by (i) the learning resource(s) the learner interacted with, and (ii) how these learning resource(s) affect learners' concept knowledge states.

### 2.1. Statistical Model for Time-Varying Graded Learner Responses to Questions

The SPARFA-Trace statistical model characterizes the probability that a learner answers a question correctly at a particular time instance in terms of (i) the learner's knowledge on every concept at this particular time instance, (ii) how the question relates to each concept, and (iii) the intrinsic difficulty of the question. To this end, let N denote the number of learners, K the number of latent concepts in the course/assessment, and T the total number of time instances throughout the course/assessment. We define the K-dimensional vectors

cⱼ^{(t)}ε [symbol] ^{K},tε{1, . . . , T},jε{1, . . . , N},

to represent the latent concept knowledge state of the j^{th} learner at time instance t. Let Q be the total number of questions. We further define the mapping

i(t,j):{1, . . . , T}×{1, . . . , N} [symbol] {1, . . . , Q},

which maps learner and time instance indices to question indices; this information can be extracted from the learner activity log. We will use the shorthand notation iⱼ^{(t)}=i(t,j) to denote the index of the question that the j^{th} learner answers iⱼ^{(t)} at time instance t. Under this notation, we define the) K-dimensional vector

$${w}_{{i}_{j}^{( t )}}^{T} ∈ {K}^{} , i ∈ \{ 1 , … , Q \} ,$$

as the question-concept association vector of the question that the j^{th} learner answered at time instance t. Finally, we define the scalar

$${μ}_{{i}_{j}^{( t )}} ∈$$

to be the intrinsic difficulty of question iⱼ^{(t)}, with large, positive values of

$${μ}_{{i}_{j}^{( t )}}$$

representing difficult questions, while a small, negative values of

$${μ}_{{i}_{j}^{( t )}}$$

representing easy ones.

Given these quantities, we characterize the binary-valued graded response, where 1 denotes a correct response and 0 an incorrect response, of learner j to question iⱼ^{(t)} at time instance t as a Bernoulli random variable:

$${Y}_{j}^{( t )} \sim Ber ( Φ ( {Z}_{j}^{( t )} ) ) , ( t , j ) ∈ {Ω}_{obs} , \\ {Z}_{j}^{( t )} = {w}_{{i}_{j}^{( t )}}^{T} {c}_{j}^{( t )} - {μ}_{{i}_{j}^{( t )}} , ∀ t , j . \qquad ( 1 )$$

Here, the set Ω_{obs}⊂{1, . . . Q}×{1, . . . N} contains the indices associated with the observed graded learner response data, since some learner responses might not be observed in practice. Φ(z) denotes the inverse probit link function Φₚᵣₒ(z)=∫_{-∞}^{z} [symbol] (t)dt, where

$$𝒩 ( t ) = \frac{1}{\sqrt{2 π}} {e}^{- {t}^{2} / 2}$$

is the probability density function (PDF) of the standard normal distribution. (Note that the inverse logit link function could also be used. However, the inverse probit link function simplifies the calculations in Section 3.3.) The likelihood of an observation Yⱼ^{(t)} can, alternatively, be written as

$$p ( {Y}_{j}^{( t )} \vert {Z}_{j}^{( t )} ) = Φ ( ( 2 {Y}_{j}^{( t )} - 1 ) ( {w}_{{i}_{j}^{( t )}}^{T} {c}_{j}^{( t )} - {μ}_{{i}_{j}^{( t )}} ) ) ,$$

a shorthand expression that we will often use in the remainder of the paper.

Following the original SPARFA framework (Lan et al. (2014)), we impose the following model assumptions:

(A1) The number of concepts is much smaller than the number of questions and the number of learners: This assumption imposes a low-dimensional model on the learners' responses to questions.

(A2) The vector wᵢ is sparse: This assumption is based on the observation that each question should only be associated with a few concepts out of all concepts in the domain of a course/assessment.

(A3) The vector wᵢ has non-negative entries: This assumption enables one to interpret the entries in cⱼ to be the latent concept knowledge of each learner, with positive values representing high concept knowledge, and negative values representing low concept knowledge.

These assumptions are reasonable in the majority of real-world educational scenarios and alleviate the common identifiability issue inherent to factor analysis. To illustrate, if Z_{i,j}=wᵢ^{T}cⱼ, then for any orthonormal matrix Q with Q^{T}Q=I we have

Z_{i,j}=Wᵢ^{T}Q^{T}Qcⱼ=\tilde{w}ᵢ^{T}\tilde{c}ⱼ.

Hence, the estimation of wᵢ and cⱼ is, in general, non-unique up to a unitary unitary transformation. See Harman (1976) and Lan et al. (2014) for more details. The assumptions also improve the interpretability of the variables wᵢ, cⱼ, and μᵢ.

### 2.2. Statistical Model for Learner Knowledge State Transitions

The SPARFA model (1) assumes that each learner's concept knowledge remains constant throughout a course/assessment. Although this assumption is valid in the setting of a single test or exam, it provides limited explanatory power in analyzing the (possibly semester-long) process of a course, during which the learners' concept knowledge evolves through time. We assume here that the concept knowledge state evolves for two primary reasons: (i) A learner may interact with learning resources (e.g., read a section of an assigned textbook, watch a lecture video, conduct a lab experiment, or nm a computer simulation), all of which are likely to result in an increase of their concept knowledge. (ii) A learner may simply forget a learned concept, resulting in a decrease of their concept knowledge. For the sake of simplicity of exposition, we will treat the forgetting effect (Weiner and Reed (1969)) as a special learning resource that reduces learners' concept knowledge over time.

We propose a latent state transition model that models learner concept knowledge evolution between two consecutive time instances. To this end, we assume that there are a total of M distinct learning resources. We define the mapping

m(t,j):{1, . . . T}×{1, . . . N} [symbol] {1, . . . M}

from time and learner indices to learning resource indices; this information can be extracted from the learner activity log. We will use the shorthand notation mⱼ^{(t-1)} to denote the index of the learning resource that learner j studies between time instance t−1 and time instance t. Armed with this notation, the learner activity summary matrices R^{(t)} illustrated in FIG. 1B are defined by

$${R}_{j , {m}_{j}^{( t )}}^{( t )} = 1 , ∀ ( t , j ) ,$$

meaning that learner j interacted with learning resource mⱼ^{(t)} at time instance t, and 0 otherwise.

We are now ready to model the transition of learner j's latent concept knowledge state from time instance t−1 to t as

$$\begin{matrix}{c}_{j}^{( t )} = ( {I}_{K} + {D}_{{m}_{j}^{( t - 1 )}} ) {c}_{j}^{( t - 1 )} + {d}_{{m}_{j}^{( t - 1 )}} + {ε}_{j}^{( t - 1 )} , & ( 2 A ) \\ {ε}_{j}^{( t - 1 )} \sim 𝒩 ( {0}_{K} , {Γ}_{{m}_{j}^{( t - 1 )}} ) , & ( 2 B )\end{matrix}$$

where I_{K} is the K×K identity matrix;

$${D}_{{m}_{j}^{( t - 1 )}} , {d}_{{m}_{j}^{( t - 1 )}} , and {Γ}_{{m}_{j}^{( t - 1 )}}$$

are latent learner concept knowledge state transition parameters, which define an affine model on the transition of the j^{th} learner's concept knowledge state by interacting with learning resource mⱼ^{(t-1)} between time instances t−1 and t.

$${D}_{{m}_{j}^{( t - 1 )}}$$

is a K×K matrix,

$${d}_{{m}_{j}^{( t - 1 )}}$$

is a K×1 vector, and 0_{K} is the K-dimensional zero vector. The covariance matrix

$${Γ}_{{m}_{j}^{( t - 1 )}}$$

characterizes the uncertainty induced in the learner concept knowledge state transition by interacting with learning resource mⱼ^{(t-1)}. Note that (2) also has the following equivalent form

$$p ( {c}_{j}^{( t )} \vert {c}_{j}^{( t - 1 )} ) = N ( {c}_{j}^{( t )} \vert ( {I}_{k} + {D}_{{m}_{j}^{( t - 1 )}} ) {c}_{j}^{( t - 1 )} + {d}_{{m}_{j}^{( t - 1 )}} , {Γ}_{{m}_{j}^{( t - 1 )}} ) , \qquad ( 3 )$$

where [symbol] (μ|Σ) represents a multivariate Gaussian distribution with mean vector μ and covariance matrix Σ.

In order to reduce the number of parameters and to improve identifiability of the parameters

$${D}_{{m}_{j}^{( t - 1 )}} , {d}_{{m}_{j}^{( t - 1 )}} , and {Γ}_{{m}_{j}^{( t - 1 )}} ,$$

we impose three additional assumptions on the learner knowledge state transition matrix

$${D}_{{m}_{j}^{( t - 1 )}} ,$$

as follows.

(A4)

$${D}_{{m}_{j}^{( t - 1 )}}$$

is lower triangular: This assumption means that, the k^{th} entry in the learner concept knowledge vector cⱼ^{(t)} is only influenced by the 1^{st}, . . . , k−1^{th} entry in cⱼ^{(t)}. As a result, the upper entries in cⱼ^{(t)} represent pre-requisite concepts that are covered early in the course, while lower entries represent advanced concepts that are covered towards the end of the course. Using this assumption, it is possible to extract prerequisite relationships among concepts purely from learner response data.

(A5)

$${D}_{{m}_{j}^{( t - 1 )}}$$

has non-negative entries: This assumption Dₘ ensures, for example, that having low concept knowledge at time instance t−1 (negative entries in cⱼ^{(t-1)} does not result in high concept knowledge at time instance t (positive entries in cⱼ^{(t)}.

(A6)

$${D}_{{m}_{j}^{( t - 1 )}}$$

is sparse: This assumption amounts for the observation that learning resources typically only cover a small subset of concepts among all concepts covered in a course.

In contrast to the learner concept knowledge transition matrix

$${D}_{{m}_{j}^{( t - 1 )}} ,$$

we do not impose sparsity or non-negativity properties on the intrinsic learner concept knowledge state transition vector

$${d}_{{m}_{j}^{( t - 1 )}}$$

in (2); large, positive values in

$${d}_{{m}_{j}^{( t - 1 )}}$$

represent learning resources with good quality that boost learners' concept knowledge, while small, negative values in

$${d}_{{m}_{j}^{( t - 1 )}}$$

represent learning resources that reduce learners' concept knowledge. This setup enables our framework to model cases of poorly designed, misleading, or off-topic learning resources that distract or confuse learners. Note that the forgetting effect can also be modeled as a learning resource with negative entries in

$${d}_{{m}_{j}^{( t - 1 )}} .$$

To further reduce the number of parameters, we assume that the covariance matrix

$${Γ}_{{m}_{j}^{( t - 1 )}}$$

is diagonal. This assumption is mainly made for simplicity; the analysis of more evolved models is left for future work.

### 3. Time-Varying Learning Analytics

Recall that time-varying LA requires an on-line algorithm that traces the evolution of learner concept knowledge over time, by analyzing binary-valued graded learner responses. Designing such an algorithm it is complicated by the fact that the binary-valued graded learner responses correspond to a non-linear and non-Gaussian observation model (resulting from (1)). A number of approaches have been proposed to handle non-linear and non-Gaussian on-line estimation problems. Particle filter (Doucet et al. (2000); Sanjeev et al. (2002)) uses a set of Monte-Carlo particles to approximately estimate the latent states. However, its huge computational complexity prevents it from being applied to personalized learning at large scale, which requires immediate feedback. The Kalman filter (Kalman (1960)) is an efficient approach for on-line state estimation problems in linear dynamical systems (LDSs) with Gaussian observations. However, the Kalman filter cannot be directly applied to time-varying LA since the observed binary-valued graded learner responses are non-Gaussian. Various approximations have been proposed to fit the state estimation problem in a non-linear and non-Gaussian system into the Kalman filter framework (Wolfinger (1993); Einicke and White (1999); Wan and Van Der Merwe (2000)), but they are still too computationally extensive for our application.

We now introduce a set of computationally efficient approximations that build upon ideas in expectation propagation (Minka (2001); Rasmussen and Williams (2006)), which enable us to recast the time-varying LA problem as an approximate Kalman filter. We begin in Section 3.1 and Section 3.2 by reviewing the key elements of the Kalman filtering and smoothing approach, and then detail our approximate Kalman filter in Section 3.3.

For notational simplicity, we will omit the learner index j in this section, i.e., the quantities

$${D}_{{m}_{j}^{( t - 1 )}} and {d}_{{m}_{j}^{( t - 1 )}}$$

are replaced by Dₘ_{^{(t−1)}} and dₘ_{^{(t−1)}}. Moreover, we use the shorthand notation D̅ₘ_{^{(t−1)}} for the quantity I_{K}+Dₘ_{^{(t−1)}}.

### 3.1. Kalman Filtering

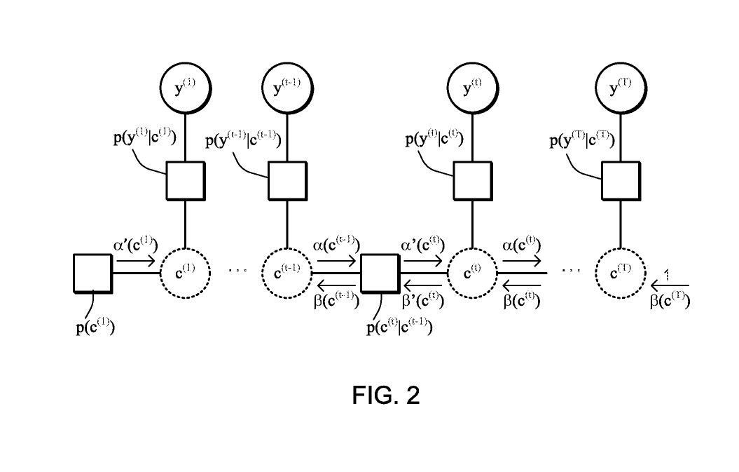

The Kalman filter (Kalman (1960); Haykin (2001)) solves the problem of state estimation in LDSs, where the system comprises a series of continuous latent state variables that are separated by linear state transitions; the state observations are corrupted by Gaussian noise. Here we briefly summarize the main findings from Minka (1999). Let the LDS comprise a series of T latent state variables c^{(t)}; t=1, . . . , T, and observations y^{(t)}; t=1, . . . , T. The factor graph (Kschischang et al. (2001); Loeliger (2004)) associated to this LDS is visualized in FIG. 2. The latent states (denoted by dashed circles) form a Markov chain, meaning that the next state only depends on the current state but not on previous ones. The Kalman filter estimation procedure of the variables c^{(t)}, ∀t based on the observations y^{(t)}, ∀t (denoted by solid circles) can be formulated as a message-passing algorithm that comprises two phases. First, a forward message passing phase (i.e., the Kalman filtering phase) is performed. Then, using the estimates obtained during the Kalman filtering phase, a backward message passing phase (often referred to as Kalman smoothing or Rauch-Tung-Streibel (RTS) smoothing) is performed.

In the forward message passing phase (see FIG. 2), the goal is to estimate latent state variables c^{(t)} based on the previous observations y⁽¹⁾, . . . , y^{(t)}. In other words, the value of interest is

p(c^{(t)}|y⁽¹⁾, . . . , y^{(t)}),∀t.

This quantity can be obtained via a message passing algorithm outlined in FIG. 2. Specifically, by starting at t=1, the incoming message to variable node c⁽¹⁾ is given by α′(c⁽¹⁾)=p(c⁽¹⁾). The outgoing message from variable node c⁽¹⁾ to factor node p(c⁽²⁾|c⁽¹⁾) is then given by

$$\begin{matrix}α ( {c}^{( 1 )} ) = {α}^{′} ( {c}^{( 1 )} ) p ( {y}^{( 1 )} \vert {c}^{( 1 )} ) \\ = p ( {c}^{( 1 )} ) p ( {y}^{( 1 )} \vert {c}^{( 1 )} ) \\ = {b}^{( 1 )} p ( {c}^{( 1 )} \vert {y}^{( 1 )} ) ,\end{matrix}$$

according to Bayes rule, where b⁽¹⁾=p(y⁽¹⁾) is a scaling factor.

Recursively following these rules, the outgoing message α(c^{(t-1)}) from variable node c^{(t-1)} to the factor node p(c^{(t)}|c^{(t-1)}) at time t is given by

α(c^{(t-1)})=(Π_{τ=}1^{t-1}b^{(τ)})p(c^{(t-1)}|y⁽¹⁾, . . . , y^{(t-1)}).

The outgoing message α′(c^{(t)}) from factor node p(c^{(t)}|c^{(t-1)}) to variable node c^{(t)} is given by

$$\begin{matrix}{α}^{′} ( {c}^{( t )} ) = \int α ( {c}^{( t - 1 )} ) p ( {c}^{( t )} \vert {c}^{( t - 1 )} ) d {c}^{( t - 1 )} \\ = ( {\prod }_{τ = 1}^{t - 1} {b}^{( τ )} ) p ( {c}^{( t )} \vert {y}^{( 1 )} , … , {y}^{( t - 1 )} ) .\end{matrix}$$

The outgoing message α(c^{(t)}) from variable node c^{(t)} is given by

α(c^{(t)})=α′(c^{(t)})p(y^{(t)}|c^{(t)})(Π_{τ=1}^{t}b^{(τ)})p(c^{(t)}|y⁽¹⁾, . . . , y^{(t)}),

where b^{(t)}=p(y^{(t)}|y⁽¹⁾, . . . , y^{(t-1)}). We can see that a scaled version of α(c^{(t)}),

$$\hat{α} ( {c}^{( t )} ) = \frac{α ( {c}^{( t )} )}{{\prod }_{τ = 1}^{t} b ( τ )} = p ( {c}^{( t )} \vert {y}^{( 1 )} , … , {y}^{( t )} ) ,$$

is exactly the value of interest.

The derivations above show that \hat{α}(c^{(t)}) can be obtained in recursive fashion via

b^{(t)}\hat{α}(c^{(t)})=p(y^{(t)}|c^{(t)})∫p(c^{(t)}|c^{(t-1)})\hat{α}(c^{(t-1)})dc^{(t-1)}. (4)

The key to obtaining a tractable and efficient estimator for p(c^{(t)}|y⁽¹⁾, . . . , y^{(t)}) is that the transition probability p(c^{(t)}|c^{(t-1)}) and the observation likelihood p(y^{(t)}|c^{(t)}) satisfy certain properties such that the messages \hat{α}(c^{(t)}) and \hat{α}(c^{(t-1)}) take on the same functional form, just with different parameters. A LDS is a special case in which the transition probability and the observation likelihood are (multivariate) Gaussians of are of the following form:

p(c^{(t)}|c^{(t-1)}= [symbol] (c^{(t)}| D̅ₘ_{^{(t−1)}}c^{(t-1)}+dₘ_{^{(t−1)}},Γₘ_{^{(t−1)}}),

p(y^{(t)}|c^{(t)})= [symbol] (y^{(t)}|Wᵢ_{^{(t)}}c^{(t)},Σᵢ_{^{(t)}}).

Here, Γₘ_{^{(t−1)}} is the covariance matrix for state transition, Wᵢ_{^{(t)}} is the measurement matrix, and Σᵢ_{^{(t)}} is the covariance matrix for the multivariate observation of the system. In order for the functional form of the messages to stay the same over time, the messages are also Gaussian, i.e.,

\hat{α}(c^{(t)})˜ [symbol] (c^{(t)}|m^{(t)},V^{(t)}).

Under these conditions, the forward message passing recursion (4) takes on a compact form

b^{(t)}\hat{α}(c^{(t)})˜ [symbol] (c^{(t)}|m^{(t)},V^{(t)}), (5)

with the parameters b^{(t)}, m^{(t)} and V^{(t)} given by

m^{(t)}= D̅ₘ_{^{(t−1)}}m^{(t-1)}+dₘ_{^{(t−1)}}+K^{(t)}(y^{(t)}−Wᵢ_{^{(t)}}( D̅ₘ_{^{(t−1)}}m^{(t-1)}+dₘ_{^{(t−1)}})),

V^{(t)}=(I_{K}−K^{(t)}Wᵢ_{^{(t)}})P^{(t-1)}, and

b^{(t)}= [symbol] (y^{(t)}|wᵢ_{^{(t)}}( D̅ₘ_{^{(t−1)}}m^{(t-1)}+dₘ_{^{(t−1)}}),Wᵢ_{^{(t)}}P^{(t-1)}Wᵢ_{^{(t)}}^{T}+Σᵢ_{^{(t)}},

in which the matrices K^{(t)} and P^{(t-1)} are given by

K^{(t)}=p^{(t-1)}wᵢ_{^{(t)}}^{T}(Wᵢ_{^{(t)}}P^{(t-1)}Wᵢ_{^{(t)}}^{T}+Σᵢ_{^{(t)}})⁻¹,

P^{(t-1)}= D̅ₘ_{^{(t−1)}}V^{(t-1)}V^{(t-1)} D̅ₘ_{^{(t−1)}}^{T}+Γₘ_{^{(t−1)}}.

The recursion starts with a prior

p(c⁽¹⁾)= [symbol] (c⁽¹⁾|m⁽⁰⁾,V⁽⁰⁾, and

m⁽¹⁾=m⁽⁰⁾K⁽¹⁾(y⁽¹⁾−Wᵢ_{⁽¹⁾}m⁽⁰⁾),

V⁽¹⁾=(I_{K}−K⁽¹⁾Wᵢ_{⁽¹⁾})V⁽⁰⁾,

K⁽¹⁾=V⁽⁰⁾Wᵢ_{⁽¹⁾}^{T}(Wᵢ_{⁽¹⁾}V⁽⁰⁾Wᵢ_{⁽¹⁾}^{T}+Σᵢ_{⁽¹⁾})⁻¹,

b⁽¹⁾= [symbol] (y¹|Wᵢ_{⁽¹⁾}m⁽⁰⁾,Wᵢ_{⁽¹⁾}V⁽⁰⁾Wᵢ_{⁽¹⁾}^{T}+Σᵢ⁽¹⁾).

We assume the initial prior mean and variance for c⁽¹⁾ to be)

m⁽⁰⁾=0_{K} and V⁽⁰⁾=σ₀²I_{K}.

### 3.2. Kalman Smoothing

As detailed above, Kalman filtering can be utilized to obtain p(c^{(t)}|y⁽¹⁾, . . . , y^{(T)}), an estimate on the latent state at time instance t, given all observations y^{(τ)} for τ<t. This estimate is the value of interest for a variety of real-time tracking applications, since decisions have to be made based on all available observations up to a certain time instance. However, in our application, one could also use observations at τ≧t to obtain a better estimate of the latent state at time instance t. In other words, the value of interest is now p(c^{(t)}|y⁽¹⁾), . . . , y^{(T)}). In order to estimate this value, a set of backward recursions similar to the set of forward recursions (4) can be used.

The backwards message starts with a “one” message going into variable node c^{(T)}: β(c^{(T)})=1 (as shown in FIG. 2). Then, the outgoing message from variable node c^{(T)} into factor node p(c^{(T)}|c^{(T-1)}) is

β′(c^{(T)})=p(y^{(T)}|c^{(T)}),

and the outgoing message from factor node p(c^{(T)}|c^{(T-1)}) into variable node c^{(T-1)} is

$$\begin{matrix}β ( {c}^{( T - 1 )} ) = \int p ( {c}^{( T )} \vert {c}^{( T - 1 )} ) p ( {y}^{( T )} \vert {c}^{( T )} ) d {c}^{( T )} \\ = p ( {y}^{( T )} \vert {c}^{( T - 1 )} ) .\end{matrix}$$

Following this convention, we obtain the following recursion:

$$\begin{matrix}β ( {c}^{( t - 1 )} ) = \int p ( {c}^{( t )} \vert {c}^{( t - 1 )} ) p ( {y}^{( t )} \vert {c}^{( t )} ) β ( {c}^{( t )} ) d {c}^{( t )} \\ = p ( {y}^{( t )} , … , {y}^{( T )} \vert {c}^{( t - 1 )} ) ,\end{matrix}$$

where we have implicitly used the Markovian properties of the latent state variables.

Now, the marginal distribution of latent state variables c^{(t)} can be written as a product of the incoming messages into variable node c^{(t)} from both forward and backward recursions, i.e.,

$$\begin{matrix}p ( {c}^{( t )} \vert {y}^{1} , … , {y}^{( T )} ) = \frac{p ( {c}^{( t )} \vert {y}^{1} , … , {y}^{( T )} ) p ( {y}^{( t + 1 )} , … , {y}^{( T )} \vert {y}^{1} , … , {y}^{( t )} )}{p ( {y}^{( t + 1 )} , … , {y}^{( T )} \vert {y}^{1} , … , {y}^{( t )} )} \\ = \hat{α} ( {c}^{( t )} ) \hat{β} ( {c}^{( t )} ) ,\end{matrix}$$

$$where \hat{β} ( {c}^{( t )} ) = \frac{β ( {c}^{( t )} )}{{\prod }_{τ = t + 1}^{T} b ( τ )}$$

is a scaled version of β(c^{(t)}).

Now the backward recursion is as follows:

b^{(t)}\hat{β}(c^{(t-1)})=∫p(c^{(t)}|c^{(t-1)})p(y^{(t)}|c^{(t)})\hat{β}(c^{(t)})dc^{(t)}. (6)

Although it is possible to obtain a backward recursion for \hat{β}(c^{(t)}), the common approach uses a recursion directly on \hat{α}(c^{(t)})\hat{β}c^{(t)}) to obtain the value of interest p(c^{(t)}|y¹, . . . , y^{(T)}). By multiplying both sides of the equation (6) by \hat{α}(c^{(t-1)}), we obtain

$$\hat{α} ( {c}^{( t - 1 )} ) \hat{β} ( {c}^{( t - 1 )} ) = \hat{α} ( {c}^{( t - 1 )} ) \int p ( {c}^{( t )} \vert {c}^{( t - 1 )} ) p ( {y}^{( t )} \vert {c}^{( t )} ) \frac{\hat{α} ( {c}^{( t )} ) \hat{β} ( {c}^{( t )} )}{{b}^{( t )} \hat{α} ( {c}^{( t )} )} d {c}^{( t )} ,$$

which can be computed recursively as a backward message passing process, given the estimates (5) following the completion of the forward message passing process detailed in Section 3.1.

For an LDS, the recursions take the form:

\hat{α}(c^{(t-1)})\hat{β}(c^{(t-1)})=p(c^{(t-1)})|\hat{m}^{(t-1)},\hat{V}^{(t-1)} (7)

with the parameters \hat{m}^{(t-1)} and \hat{V}^{(t-1)} given by

\hat{m}^{(t-1)}=m^{(t-1)}+j^{(t-1)}(\hat{m}^{(t)}− D̅ₘ_{^{(t−1)}}m^{(t-1)}),

\hat{V}^{(t-1)}=V^{(t-1)}+J^{(t-1)}(\hat{V}^{(t)}−P^{(t-1)})(J^{(t-1)})^{T},

J^{(t-1)}=V^{(t-1)} D̅ₘ_{^{(t−1)}}^{T}(P^{(t-1)})⁻¹.

We initialize the recursion with \hat{m}^{(T)}=m^{(T)} and \hat{V}^{(T)}=V^{(T)}, since β(c^{(T)})=1.

In the above derivations, we have assumed that y^{(t)} is observed for all t. If y^{(t)} is unobserved, then the message passing scheme will simply have α(c^{(t)})=\hat{α}(c^{(t)}) and β′(c^{(t)})=β(c^{(t)}) instead, while the rest of the recursions remain unaffected.

### 3.3. Approximate Kalman Filtering for Learner Concept Knowledge Tracing

The basic Kalman filtering and smoothing ((5) and (7)) are only suitable for applications with a Gaussian latent state transition model and a Gaussian observation model, while the forward and backward recursions (4) and (6) hold for arbitrary state transition and observation models. When attempting to trace latent learner concept knowledge states under the SPARFA-Trace model, it is not possible to make Gaussian observations of these states. Concretely, we have only binary-valued graded learner responses as our observations. We will now detail approximations that enable the estimation of latent learner concept knowledge states under our model.

As introduced in Section 2, the observation model at time t is given by (1) and the state transition model is given by (3). Therefore, the recursion formula for the forward message passing process (4) becomes

$$\begin{matrix}{b}^{( t )} \hat{α} ( {c}^{\\ ( t )} ) = p ( {Y}^{( t )} \vert {c}^{( t )} ) \int p ( {c}^{( t )} \vert {c}^{( t - 1 )} ) \hat{α} ( {c}^{( t - 1 )} ) d {c}^{( t - 1 )} \\ = Φ ( ( 2 {Y}^{( t )} - 1 ) ( {w}_{{i}^{( t )}}^{T} {c}^{( t )} - {μ}_{{i}^{( t )}} ) ) \int Z d {c}^{( t - 1 )} ,\end{matrix}$$

where integrand Z equals

[symbol]

(c^{(t)}| D̅ₘ^{(t-1)}c^{(t-1)}+dₘ_{^{(t−1)}}) [symbol] (c^{(t-1)}|m^{(t-1)},V^{(t-1)})

### Thus,

$$\begin{matrix}\int Z d {c}^{( t - 1 )} = 𝒩 ( {c}^{( t )} \vert {\overline{D}}_{{m}^{( t - 1 )}} {m}^{( t - 1 )} + {d}_{{m}^{( t - 1 )}} , {\overline{D}}_{{m}^{( t - 1 )}} {Γ}_{{m}^{( t - 1 )}} {\overline{D}}_{{m}^{( t - 1 )}}^{T} ) \\ = 𝒩 ( {c}^{( t )} \vert {\tilde{m}}^{( t )} , {\tilde{V}}^{( t )} )\end{matrix}$$

where we used a tilde to denote the mean and covariance of the messages α′(c^{(t-1)})

Equation (8) shows that, α(c^{(t)}) is no longer Gaussian even if \hat{α}(c^{(t-1)}) is Gaussian, under the probit binary observation model. Thus, the closed-form updates in (5) and (7) can no longer be applied. Therefore, we need to perform an approximate message passing approach within the Kalman filtering framework to arrive at a tractable estimator of c^{(t)}. A number of approaches has been proposed to approximate \hat{α}(c^{(t)}) by a Gaussian distribution [symbol] c^{(t)}| m̅^{(t)}, V̅^{(t)}); here, the bar on the variables denote the means and covariances of the approximated Gaussian messages. These approaches include the extended Kalman filter (EKF) (Jazwinski (1970); Maybeck (1979); Einicke and White (1999)), which uses a linear approximation of the likelihood term around the point \tilde{m}^{(t)}, and thus reduce the non-Gaussian observation model to a Gaussian one; the unscented Kalman filter (UKF) (Julier and Uhlmann (1997); Wan and Van Der Merwe (2000)), which uses the unscented transform (UT) to create a set of sigma vectors from p(c^{(t-1)}) and uses them to approximate the mean and covariance of \hat{α}(c^{(t)}) after the non-Gaussian observation; and Laplace approximations (Wolfinger (1993); Rasmussen and Williams (2006)), which use an iterative algorithm to find the mode of \hat{α}(c^{(t)}) and the Hessian at the mode to approximate the mean and covariance of the approximated Gaussian messages. We will employ an approximation approach introduced in the expectation propagation (EP) literature (Minka (2001)).

It is known that the specific values for m̅^{(t)} and V̅^{(t)} that minimize the Kullback-Leibler (KL) divergence between [symbol] (c^{(t)}| m̅^{(t)}, V̅^{(t)}) and a target distribution q(c) are the first and second moments of q(c) Rasmussen and Williams (2006). Fortunately, for the probit observation model

p(Y^{(t)}|c^{(t)})=Φ((2Y^{(t)}−1)(wᵢ_{^{(t)}}^{T}c^{(t)}−μᵢ_{^{(t)}})),

m̅^{(t)}, V̅^{(t)} and b^{(t)}

have closed-form expressions:

$${\overline{m}}^{( t )} = {\tilde{m}}^{( t )} + ( 2 {Y}^{( t )} - 1 ) \frac{{\tilde{V}}^{( t )} {w}_{{i}^{( t )}}}{\sqrt{1 + {w}_{{i}^{( t )}}^{T} {\tilde{V}}^{( t )} {w}_{{i}^{( t )}}}} \frac{𝒩 ( z )}{Φ ( z )} , \\ {\overline{V}}^{( t )} = {\tilde{V}}^{( t )} - \frac{{\tilde{V}}^{( t )} {w}_{{i}^{( t )}} {w}_{{i}^{( t )}}^{T} {\tilde{V}}^{( t )}}{1 + {w}_{{i}^{( t )}}^{T} {\tilde{V}}^{( t )} {w}_{{i}^{( t )}}} ( z + \frac{𝒩 ( z )}{Φ ( z )} ) \frac{𝒩 ( z )}{Φ ( z )} , \\ {b}^{( t )} = Φ ( z ) , \\ with \\ z = ( 2 {Y}^{( t )} - 1 ) \frac{{w}_{{i}^{( t )}}^{T} {\tilde{m}}^{( t )} - {μ}_{{i}^{( t )}}}{\sqrt{1 + {w}_{{i}^{( t )}}^{T} {\tilde{V}}^{( t )} {w}_{{i}^{( t )}}}} , \qquad ( 9 )$$

and \tilde{m}^{(t)} and \tilde{V}^{(t)} as given by (8).

SPARFA naturally supports two different inverse link functions for analyzing binary-valued graded learner responses: the inverse probit link function and the inverse logit link function. In this application, the inverse probit link function is preferred over the inverse logit link function, due to the existence of the closed-form first and second moments described above. The inverse logit link function is not preferred as such convenient closed-form expressions do not exist. Therefore, we will focus on the inverse probit link function in the sequel.

Armed with the efficient approximation (9), the forward Kalman filtering message passing scheme described in Section 3.1 can be applied to the problem at hand; the backward Kalman smoothing message passing scheme described in Section 3.2 remains unchanged. Using these recursions, estimates of the desired quantities p(c^{(t)}|y¹, . . . , y^{(T)}) can be computed efficiently, providing a way for learner concept knowledge tracing under the model (1).

### 4. Content Analytics

Thus far, we have described an approximate Kalman filtering and smoothing approach for learner concept knowledge tracing, i.e., to estimate p(c^{(t)}|y¹, . . . , y^{(T)}),∀t,j. The method proposed in Section 3 is only able to provide these estimates if the observed binary graded learner responses Yⱼ^{(t)}, ∀t,j, and all learner initial knowledge parameters) mⱼ⁽⁰⁾, Vⱼ⁽⁰⁾, ∀j, all learner concept knowledge state transition parameters Dₘ, dₘ, and Γₘ, ∀m, and all question parameters, wᵢ and μᵢ, ∀i, are given a priori.

However, in a typical PLS, these parameters are unknown, in general, and need to be estimated from the observed data. We now detail a set of convex optimization-based techniques to estimate the parameters mⱼ⁽⁰⁾, Vⱼ⁽⁰⁾, ∀ⱼ, Dₘ, dₘ, and Γₘ, ∀m, and wᵢ, μᵢ, ∀i, given the estimates of the latent learner concept knowledge states cⱼ^{(t)} obtained from the approximate Kalman filtering approach described in Section 3. Since the estimates of cⱼ^{(t)} are distributions rather than point estimates, SPARFA-Trace jointly traces learner concept knowledge and estimates learner, learning resource, and question-dependent parameters, using an expectation-maximization (EM) approach.

### 4.1. SPARFA-Trace: an EM Algorithm for Parameter Estimation

EM has been widely used in the Kalman filtering framework to estimate the parameters of interest in the system (see Haykin (2001) and (Bishop and Nasrabadi, 2006, Chap. 13) for more details) due to numerous practical advantages (Roweis and Ghahramani (2001)). SPARFA-Trace performs parameter estimation in an iterative fashion

in the EM framework. All parameters are initialized to random initial values, and then each iteration of the algorithm comprises two phases: (i) the current parameter estimates are used to estimate the latent state distributions p(cⱼ^{(t)}|yⱼ⁽¹⁾, . . . , yⱼ^{(T)}), ∀t, j; (ii), these latent state estimates are then used to maximize the expected joint log-likelihood of all the observed and latent state variables, i.e., to maximize

$${\sum }_{j = 1}^{N} {𝔼}_{{c}_{j}^{( 1 )}} [ log p ( {c}_{j}^{( 1 )} \vert {m}_{j}^{( 0 )} , {v}_{j}^{( 0 )} ) ] + {\sum }_{t = 2}^{T} {\sum }_{j = 1}^{N} {𝔼}_{{c}_{j}^{( t - 1 )} , {c}_{j}^{( t )}} [ log p ( {c}_{j}^{( t )} \vert {c}_{j}^{( t - 1 )} , {D}_{{m}_{j}}^{( t - 1 )} {d}_{{m}_{j}}^{( t - 1 )} {Γ}_{{m}_{j}^{( t - 1 )}} ) ] + {\sum }_{( t , j ) ∈ Ω obs}^{ } {𝔼}_{{c}_{j}^{( t )}} [ log p ( {Y}_{j}^{( t )} \vert {c}_{j}^{( t )} , {w}_{{i}_{j}^{( t )}} , {μ}_{{i}_{j}}^{( t )} ) ] , \qquad ( 10 )$$

over

mⱼ⁽⁰⁾,Vⱼ⁽⁰⁾,∀j,Dₘ,dₘ,Γₘ,∀m,wᵢ,μᵢ,∀i

in order to obtain new (and hopefully improved) parameter estimates. SPARFA-Trace alternates between these two phases until convergence, i.e., a maximum number of iterations is reached or the change in the estimated parameters between two consecutive iterations falls below a given threshold.

### 4.2. Estimating the Initial Learner Knowledge Parameters

We start with the estimation method for the learner initial knowledge parameters mⱼ⁽⁰⁾, Vⱼ⁽⁰⁾, ∀j. To this end, we minimize the expected negative log-likelihood for the j^{th} learner

$${𝔼}_{{c}_{j}^{( 1 )}} [ - log p ( {c}_{j}^{( 1 )} \vert {m}_{j}^{( 0 )} , {V}_{j}^{( 0 )} ) ] = \frac{1}{2} log \vert {V}_{j}^{( 0 )} \vert + {𝔼}_{{c}_{j}^{( 1 )}} [ \frac{1}{2} {( {c}_{j}^{( 1 )} - {m}_{j}^{( 0 )} )}^{T} {( {V}_{j}^{( 0 )} )}^{- 1} ( {c}_{j}^{( 1 )} - {m}_{j}^{( 0 )} ) ] ,$$

where |Vⱼ⁽⁰⁾| denotes the determinant of the covariance matrix Vⱼ⁽⁰⁾. Since we do not impose constraints on mⱼ⁽⁰⁾ and Vⱼ⁽⁰⁾, these estimates can be obtained as

$${m}_{j}^{( 0 )} = {𝔼}_{{c}_{j}^{( 1 )}} [ {c}_{j}^{( 1 )} ] = {\hat{m}}_{j}^{( 1 )} and$$

$${V}_{j}^{( 0 )} = {𝔼}_{{c}_{j }^{( 1 )}} [ ( {c}_{j}^{( 1 )} - {\hat{m}}_{j}^{( 1 )} ) {( {c}_{j}^{( 1 )} - {\hat{m}}_{j}^{( 1 )} )}^{T} ] = {\hat{V}}_{j}^{( 1 )} ,$$

where the estimates \hat{m}ⱼ⁽¹⁾ and \hat{V}ⱼ⁽¹⁾ are obtained from the Kalman smoothing recursions (7) in Section 3.2.

### 4.3. Estimating the Learner Concept Knowledge State Transition Parameters

Next we estimate the latent learner concept knowledge state transition (i.e., learning resource) parameters Dₘ, dₘ, and Γₘ, ∀m. To this end, define [symbol] ^{m} as the set containing time and learner indices (t,j), indicating that learner j studies the m^{th} learning resource between time instances t−1 and t. With this definition, we aim to minimize the expected negative log-likelihood

$${\sum }_{t , j : ( t , j ) ∈ {ℳ}^{m}}^{ } {𝔼}_{{c}_{j}^{( t - 1 )} , {c}_{j}^{( t )}} [ - log p ( {c}_{j}^{( t )} \vert {c}_{j}^{( t - 1 )} , {D}_{{m}_{j}^{( t - 1 )}} , {d}_{{m}_{j}^{( t - 1 )}} , {Γ}_{{m}_{j}^{( t - 1 )}} ) ] = {\sum }_{t , j : ( t , j ) ∈ {ℳ}^{m}}^{ } ( \frac{1}{2} log \vert {Γ}_{m} \vert + {𝔼}_{{c}_{j}^{( t - 1 )} , {c}_{j}^{( t )}} ] [ \begin{matrix}\frac{1}{2} {( {c}_{j}^{( t )} - {c}_{j}^{( t - 1 )} - {D}_{m} {c}_{j}^{( t - 1 )} - {d}_{m} )}^{T} \\ {Γ}_{m}^{- 1} ( {c}_{j}^{( t )} - {c}_{j}^{( t - 1 )} - {D}_{m} {c}_{j}^{( t - 1 )} - {d}_{m} )\end{matrix} ] )$$

subject to the assumptions (A4)-(A6). We start by estimating Dₘ and dₘ given and then use these estimates to estimate

In order to induce sparsity on Dₘ to take (A6) into account, we impose an l₁-norm penalty on Dₘ, which is defined as the sum of the absolute values of all entries of Dₘ (Hastie et al. (2010)). Taking only the terms containing Dₘ and dₘ, we can formulate the following augmented optimization problem:

$$( {P}_{d} ) {min}_{{D}_{m} ∈ {L}^{+} , {d}_{m}} {\sum }_{t , j : ( t , j ) ∈ {ℳ}^{m}}^{ } {𝔼}_{{c}_{j}^{( t - 1 )} , {c}_{j}^{( t )}} [ {( {\tilde{D}}_{m} {\tilde{c}}_{j}^{( t - 1 )} )}^{T} {Γ}_{m}^{- 1} ( {\tilde{D}}_{m} {\tilde{c}}_{j}^{( t - 1 )} ) - {( {c}_{j}^{( t )} - {c}_{j}^{( t - 1 )} )}^{T} {Γ}_{m}^{- 1} ( {c}_{j}^{( t )} - {c}_{j}^{( t - 1 )} ) ] + γ {‖ {D}_{m} ‖}_{1} ,$$

where [symbol] ⁺ denotes the set of lower-triangular matrices with non-negative entries. For notational simplicity, we have written [Dₘ dₘ] as \tilde{D}ₘ. We also write the augmented latent state vectors [(cⱼ^{(t-1)})^{T}1] as \tilde{c}ⱼ^{(t-1)}, when multiplied by \tilde{D}ₘ, correspondingly. Note that the \tilde{D}ₘ-norm penalty only applies to the matrix Dₘ in the used notation.

The problem (P_{d}) is convex in \tilde{D}ₘ, and hence, can be solved efficiently. In particular, we use the fast iterative shrinkage and thresholding algorithm (FISTA) framework (Beck and Teboulle (2009)). The FISTA algorithm starts with a random initialization of \tilde{D}ₘ and iteratively updates \tilde{D}ₘ until a maximum number of iterations Lₘₐₓ is reached or the change in the estimate of \tilde{D}ₘ between two consecutive iterations falls below a certain threshold. In each iteration l=1, 2, . . . , Lₘₐₓ, the algorithm performs two steps. First, a gradient step that aims to lower the cost function performs

\hat{D}ₘ^{l+1}←\hat{D}ₘ^{l}−ηₗ∇f(\tilde{D}ₘ), (11)

where f(\tilde{D}ₘ) corresponds to the differentiable part of the cost function (excluding the l₁-norm penalty) in (P_{d}).

The quantity ηₗ is a step size parameter for iteration l. For simplicity, we will take ηₗ=1/L in all iterations, where L is the Lipschitz constant given by

$$L = {σ}_{ma x} ( {\sum }_{t , j : ( t , j ) ∈ {M}^{m}} {𝔼}_{{c}_{j}^{( t - 1 )} , {c}_{j}^{( t )}} [ ( {c}_{j}^{( t )} - {c}_{j}^{( t - 1 )} ) {( {c}_{j}^{( t - 1 )} )}^{T} ] ) \cdot {σ}_{ma x} ( \vert {M}^{m} \vert {Γ}_{m}^{- 1} ) .$$

Here σₘₐₓ(•) denotes the maximum singular value of a matrix, and | [symbol] ^{m}| denotes the cardinality of the set [symbol] ^{m}.

The gradient ∇f(\tilde{D}ₘ) in (11) is given by

$$\begin{matrix}∇ f ( {\tilde{D}}_{m} ) = - {Γ}_{m}^{- 1} {\sum }_{t , j : ( t , j ) ∈ {ℳ}^{m}}^{ } ( \begin{matrix}{𝔼}_{{c}_{j}^{( t - 1 )} , {c}_{j}^{( t )}} [ ( {c}_{j}^{( t )} - {c}_{j}^{( t - 1 )} ) {( {\tilde{c}}_{j}^{( t - 1 )} )}^{T} ] - \\ {D}_{m}^{𝓁} {𝔼}_{{c}_{h}^{( t - 1 )}} [ {{\tilde{c}}_{j}^{( t - 1 )} ( {\tilde{c}}_{j}^{( t - 1 )} )}^{T} ]\end{matrix} ) \\ = - {Γ}_{m}^{- 1} {\sum }_{t , j : ( t , j ) ∈ {ℳ}^{m}}^{ } ( \begin{matrix}[ \begin{matrix}{J}_{j}^{( t - 1 )} {\hat{V}}_{j}^{( t )} + {{\hat{m}}_{j}^{( t )} ( {\hat{m}}_{j}^{( t )} )}^{T} - {\hat{V}}_{j}^{( t - 1 )} - \\ {{\hat{m}}_{j}^{( t - 1 )} ( {\hat{m}}_{j}^{( t - 1 )} )}^{T} {\hat{m}}_{j}^{( t )} - {\hat{m}}_{j}^{( t - 1 )}\end{matrix} ] - \\ {D}_{m}^{𝓁} [ \begin{matrix}{\hat{V}}_{j}^{( t - 1 )} + {{\hat{m}}_{j}^{( t - 1 )} ( {\hat{m}}_{j}^{( t - 1 )} )}^{T} & {\hat{m}}_{j}^{( t - 1 )} \\ {( {\hat{m}}_{j}^{( t - 1 )} )}^{T} & 1\end{matrix} ]\end{matrix} ) .\end{matrix}$$

The parameters Jⱼ^{(t-1)}, \hat{m}ⱼ^{(t-1)}, \hat{m}ⱼ^{(t)}, \hat{V}ⱼ^{(t-1)}, and \hat{V}ⱼ^{(t)} are obtained from the backward recursions in (7).

Next, the FISTA algorithm performs a projection step, which takes into account the sparsifying regularizer γ∥Dₘ∥₁, and the assumptions (A4) and (A5):

\tilde{D}ₘ^{l+1}← [symbol] +(max{\hat{D}ₘ^{l+1}−γηₗ,0}), (12)

where [symbol] +(•) corresponds to the projection onto the set of lower-triangular matrices by setting all entries in the upper triangular part of \hat{D}ₘ^{l+1} to zero. The maximum operator operates element-wise on \hat{D}ₘ^{l+1}. The updates (11) and (12) are repeated until convergence, eventually providing a new estimate \tilde{D}ₘ^{new} for [Dₘ dₘ].

Using these new estimates, the update for Γₘ can be computed in closed form:

$${Γ}_{m}^{new} = \frac{1}{{ℳ}^{m}} {\sum }_{t , j : ( t , j ) ∈ {ℳ}^{m}}^{ } ( {𝔼}_{{c}_{j}^{( t )}} [ {{c}_{j}^{( t )} ( {c}_{j}^{( t )} )}^{T} ] - {D}_{m}^{new} {𝔼}_{{c}_{j}^{( t - 1 )} , {c}_{j}^{( t )}} [ {{\tilde{c}}_{j}^{( t - 1 )} ( {\tilde{c}}_{j}^{( t )} )}^{T} ] - {𝔼}_{{c}_{j}^{( t - 1 )} , {c}_{j}^{( t )}} [ {{c}_{j}^{( t )} ( {\tilde{c}}_{j}^{( t )} )}^{T} ] {( {\tilde{D}}_{m}^{new} )}^{T} ) + {\tilde{D}}_{m}^{new} {𝔼}_{{c}_{j}^{( t - 1 )}} [ {{\tilde{c}}_{j}^{( t - 1 )} ( {\tilde{c}}_{j}^{( t - 1 )} )}^{T} ] {( {\tilde{D}}_{m}^{new} )}^{T} ) = \frac{1}{{ℳ}^{m}} {\sum }_{t , j : ( t , j ) ∈ {ℳ}^{m}}^{ } ( {\hat{V}}_{j}^{( t )} + {{\hat{m}}_{j}^{( t )} ( {\hat{m}}_{j}^{( t )} )}^{T} - {\tilde{D}}_{m}^{new} [ \begin{matrix}{\hat{V}}_{j}^{( t )} + {{\hat{m}}_{j}^{( t )} ( {\hat{m}}_{j}^{( t - 1 )} )}^{T} \\ {( {\hat{m}}_{j}^{( t )} )}^{T}\end{matrix} ] - [ {J}_{j}^{( t - 1 )} {\hat{V}}_{j}^{( t )} + {{\hat{m}}_{j}^{( t )} ( {\hat{m}}_{j}^{( t - 1 )} )}^{T} {\hat{m}}_{j}^{( t )} ] {( {\tilde{D}}_{m}^{new} )}^{T} + {D}_{m}^{new} [ \begin{matrix}{\hat{V}}_{j}^{( t - 1 )} + {{\hat{m}}_{j}^{( t - 1 )} ( {\hat{m}}_{j}^{( t - 1 )} )}^{T} & {\hat{m}}_{j}^{( t - 1 )} \\ {( {\hat{m}}_{j}^{( t - 1 )} )}^{T} & 1\end{matrix} ] {( {\tilde{D}}_{m}^{new} )}^{T} ) .$$

### 4.4. Estimating the Question-Dependent Parameters

We next show how to estimate the question-dependent parameters wᵢ, μᵢ, ∀i. To this end, we define [symbol] ⁱ as the collection set of time and learner indices (t, j) that learner j answered the i^{th} question at time instance t. We then minimize the expected negative log-likelihood of all the observed binary-valued graded learner responses (1) for the i^{th} question subject to assumptions (A2) and (A3) on the question-concept association vector wᵢ. In order to impose sparsity on wᵢ, we add an l₁-norm penalty to the cost function, which leads to the following optimization problem:

$$( {P}_{w} ) {min}_{{w}_{i} : {w}_{i , k} \geq 0 , ∀ k} {\sum }_{( t , j ) ∈ {Q}^{i}}^{ } {𝔼}_{{c}_{j}^{( t )}} [ - log Φ ( ( 2 {Y}_{j}^{( t )} - 1 ) ( {w}_{i}^{T} {c}_{j}^{( t )} - {μ}_{i} ) ) ] + λ {‖ {w}_{i} ‖}_{1} .$$

This problem corresponds to the (RR₁⁺) problem of SPARFA detailed in Lan et al. (2014), where the point estimates of cⱼ^{(t)} are given and the problem is convex in wᵢ. In particular, given the distribution cⱼ^{(t)}˜ [symbol] (cⱼ^{(t)}|\hat{m}ⱼ^{(t)}, \hat{V}ⱼ^{(t)}), (P_{W}) is still convex in wᵢ, thanks to the linearity of the expectation operator. However, the inverse probit link function prohibits us from obtaining a simple form of this expectation. In order to develop a tractable algorithm to approximately solve this problem, we utilize the unscented transform (UT) (Wan and Van Der Merwe (2000)) to approximate the cost function of (P_{w}).

The UT is commonly used in the Kalman filtering literature to approximate the statistics of a random variable undergoing a non-linear transformation. Specifically, given a K-dimensional random variable x with known mean and covariance and a non-linear function g(•), the UT generates a set of 2K+1 so-called sigma vectors {χₙ} and a set of corresponding weights {uₙ} as detailed in (Wan and Van Der Merwe, 2000, Eq. 15), in order to approximate the mean and covariance of the vector y=g(x). As shown in Wan and Van Der Merwe (2000), this approximation is accurate up to the third order for Gaussian distributed random vectors x.

Following the paradigms of the UT, we generate a set of sigma vectors {(\tilde{c}ⱼ^{(t)})ₙ} and a corresponding set of weights {uₙ}, nε{1, 2, . . . , 2K+1}, for each latent state vector cⱼ^{(t)}, given the mean \hat{m}ⱼ^{(t)} and covariance \hat{V}ⱼ^{(t)}. For computational simplicity, we will use the same set of weights for all latent state vectors cⱼ^{(t)}.

The optimization problem (P_{w}) can now be approximated by

$${min}_{{w}_{i} : {w}_{i , k} \geq 0 , ∀ k} {\sum }_{( t , j ) ∈ {Q}^{i}}^{ } {\sum }_{n = 1}^{2 K + 1} {u}_{n} ( - log Φ ( ( 2 {Y}_{k}^{( t )} - 1 ) ( {w}_{i}^{T} ( {\tilde{c}}_{j}^{( t )} ) - {μ}_{i} ) ) ) + λ {‖ {w}_{i} ‖}_{1} ,$$

which, once again, can be solved efficiently by using the FISTA framework.

The resulting iterative procedure performs two steps in each iteration l, as follows.

First, a gradient step that aims at lowing the cost function performs

ŵᵢ^{l+1}←ŵᵢ^{l}−ηₗ∇f(wᵢ), (13)

where f(wᵢ) corresponds to the differentiable portion (excluding the l₁-norm penalty part) of the cost function in (P_{w}). The gradient ∇f(wᵢ) is given by ∇f(wᵢ)=−\tilde{C}ᵢ\tilde{r}ᵢ, where \tilde{r}ᵢ is a (2K+1)| [symbol] ⁱ|×1 vector \tilde{r}ᵢ=[aᵢ¹, . . . , aᵢ^{|} [symbol] ^{ⁱ}^{|}]^{T}. The vector aᵢ^{q} is defined by

aᵢ^{q}=[(gᵢ^{q})₁, . . . ,(gᵢ^{q})_{2K+1}],

where

$${( {g}_{i}^{q} )}_{n} = {u}_{n} ( 2 {Y}_{{j}_{q}}^{( {t}_{q} )} - 1 ) \frac{𝒩 ( ( 2 {Y}_{{j}_{q}}^{( {t}_{q} )} - 1 ) {{w}_{i}^{T} ( {\tilde{c}}_{{j}_{q}}^{( {t}_{q} )} )}_{n} )}{Φ ( ( 2 {Y}_{{j}_{q}}^{( {t}_{q} )} - 1 ) {{w}_{i}^{T} ( {\tilde{c}}_{{j}_{q}}^{( {t}_{q} )} )}_{n} )} ,$$

in which (t_{q},j_{q}) represents the q^{th} time-learner index pair in [symbol] ⁱ. The K×(2K+1)| [symbol] ⁱ| matrix \tilde{C}ᵢ is defined as \tilde{C}ᵢ=[(Gᵢ)₁, . . . , (Gᵢ)_{|} [symbol] _{ⁱ}_{|}], where the K×(2K+1) matrix (Gᵢ)_{q} is given by

(Gᵢ)_{q}=[(\tilde{c}ⱼ_{_{q}}^{(t}^{_{q}}⁾)₁, . . . , (\tilde{c}ⱼ_{_{q}}^{(t}^{_{q}}⁾)_{2K+1}].

The quantity ηₗ is a step size parameter for iteration l. For simplicity, we will take ηₗ=1/L in all iterations, where L is the Lipschitz constant given by L=σₘₐₓ(\tilde{C}ᵢ)σₘₐₓ(\tilde{C}ᵢ′), where \tilde{C}ᵢ′ is a K×(2K+1)| [symbol] ⁱ| matrix defined as \tilde{C}ᵢ′=[(Gᵢ′)₁, . . . , (Gᵢ′)_{|} [symbol] _{ⁱ}_{|}], where the K×(2K+1) matrix (Gᵢ′)_{q} is given by

(Gᵢ′)_{q}=[u₁(\tilde{c}ⱼ_{_{q}}^{(t}^{_{q}}⁾)₁, . . . , u_{2K+1}(\tilde{c}ⱼ_{_{q}}^{(t}^{_{q}}⁾)_{2K+1}].

Next, the FISTA algorithm performs a projection step, which takes into account λ∥wᵢ∥₁ and the assumption (A3):

wᵢ^{l+1}←max{ŵᵢ^{l+1}−ληₗ}. (14)

The steps (13) and (14) are repeated until convergence, providing a new estimate wᵢ^{new} of the question-concept association vector wᵢ. For simplicity of exposition, the question intrinsic difficulties μᵢ are omitted in the derivations above, as they can be included as an additional entry in wᵢ as [wᵢ^{T}μᵢ]^{T}; the corresponding latent learner concept knowledge state vectors cⱼ^{(t)} are augmented as [(cⱼ^{(t)})^{T}1]^{T}.

### 5. Experimental Results

We now demonstrate the efficacy of SPARFA-Trace on synthetic and real-world educational datasets. We begin by performing experiments using synthetic data to demonstrate that SPARFA-Trace is able to accurately trace latent learner concept knowledge and accurately estimate learner concept knowledge state transition parameters and question-dependent parameters. We then compare SPARFA-Trace against two established methods on predicting unobserved binary-valued learner response data, namely knowledge tracing (KT) (Corbett and Anderson (1994); Pardos and Heffernan (2010)) and SPARFA (Lan et al. (2014)). Finally, we show how SPARFA-Trace is able to visualize learners' concept knowledge state evolution over time, and the learning resource and question quality and their content organization. For all the synthetic and real data experiments shown next, the regularization parameters A, y, and ad are chosen via cross-validation (Hastie et al. (2010)), and all experiments are repeated for 25 independent Monte-Carlo trials for each instance of the model parameter we control.

5.1. Experiments with Synthetic Data

In the following experiments with synthetic data, we assess the performance of SPARFA-Trace in both (i) learner concept knowledge tracing, and (ii) estimating all learner concept knowledge state transition parameters and question-dependent parameters.

Dataset: We generate the learning resource-induced learner knowledge state transition parameters

Dₘ,dₘ,Γₘ,mε{1, . . . , M},

wᵢ,μᵢ,iε{1, . . . , Q},

under the assumptions (A1)-(A6), and randomly generate learner prior parameters mⱼ⁽⁰⁾ and Vⱼ⁽⁰⁾, jε{1, . . . , N}. Using these parameters, we randomly generate latent learner concept knowledge states and observed binary-valued graded responses Yⱼ^{(t)}, tε{1, . . . , T}, according to (1) and (2). The number of time instances is T=100, and one question is assigned to every learner at every time instance, so Q=T=100. The dataset comprises 10 assignment sets, each consisting of 10 questions. The learners' concept knowledge states evolve between consecutive assignment sets, induced by their interaction with learning resources. Therefore, the number of learning resources is M=9. There are a total of K=5 concepts; this choice is shown to be reasonable for real-world educational scenarios (see, e.g., Fronczyk et al. (2013, submitted) for a corresponding discussion).

Learner concept knowledge tracing: For the learner concept knowledge state estimation experiment, we fix the number of learners as N=50 and vary the percentage of observed entries in the Q×N learner response matrix Y as {100%, 75%, 50%, 25%} and calculate the normalized concept knowledge state estimation error

$${E}_{c} = \frac{1}{NT} {\sum }_{( t , j )}^{ } \frac{{‖ {m}_{j}^{( t )} - {c}_{j}^{( t )} ‖}_{2}^{2}}{{‖ {c}_{j}^{( t )} ‖}_{2}^{2}} . \qquad ( 15 )$$

In this experiment, all learner-dependent and learner concept knowledge state transition and question parameters are assumed to be known. Thus, we only run the Kalman filtering and smoothing part of SPARFA-Trace.

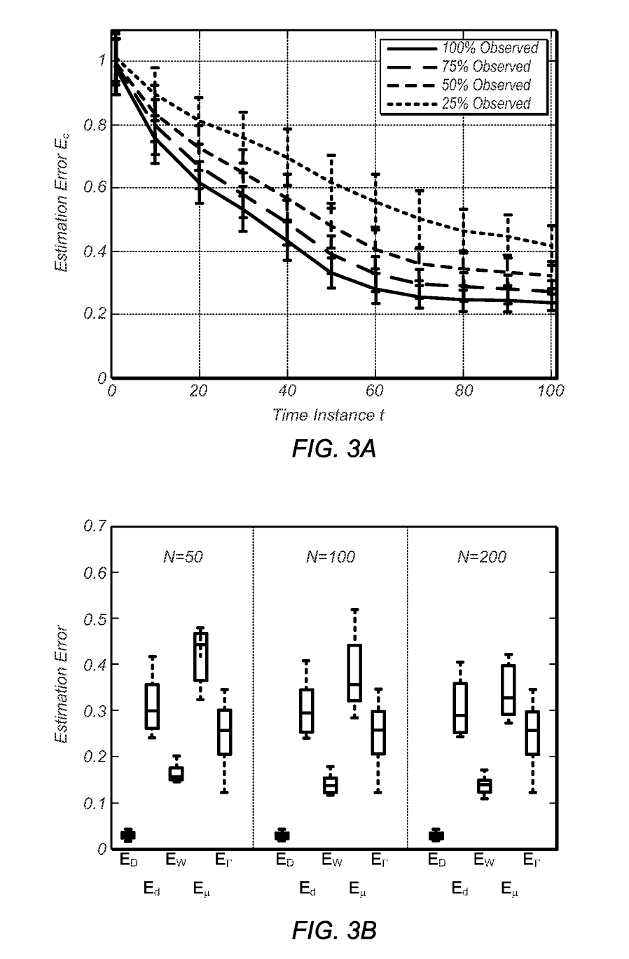

FIG. 3A shows the results from the learner concept knowledge state estimation experiment. We observe that the estimation of learner concept knowledge states becomes increasingly accurate as time proceeds. The performance of SPARFA-Trace decreases as the percentage of missing observations increases. Moreover, SPARFA-Trace can still obtain accurate estimates of cⱼ^{(t)} even when only a small portion of the response data is observed.

Estimating learner concept knowledge state transition and question parameters: To assess SPARFA-Trace on the estimation performance of learner concept knowledge state transition and question parameters, we perform a second experiment, which focus on the estimation of all learning resource and question-dependent parameters: Dₘ, dₘ, Γₘ, ∀m, wᵢ, μi, ∀. The learner concept knowledge states cⱼ^{(t)} are not given and are estimated simultaneously, while we treat the learner prior parameters mⱼ⁽⁰⁾ and Vⱼ⁽⁰⁾, ∀j as given, to avoid the scaling unidentifiability issue in the model (one can arbitrarily scale the learner concept knowledge state vectors cⱼ^{(t)} and adjust the scale of the question-concept concept association vectors wᵢ accordingly, and still arrive at the same likelihood for the observations. See, e.g., Lan et al. (2014) for a detailed discussion). We fix the number of concepts as K=5, vary the number of learners as Nε{50,100,200}, and examine the estimation error of SPARFA-Trace on all instructional and question-dependent parameters using a similar metric as in (15). The observed learner response matrix Y is assumed to be fully observed. We run SPARFA-Trace until convergence to provide estimates of all unknown parameters.

FIG. 3B shows the box-and-whisker plots of the estimation error on all five types of parameters for different numbers of learner N. We can see that the parameter estimation performance of SPARFA-Trace improves as the number of learners increase. More importantly, SPARFA-trace provides accurate estimates of these parameters even when the problem size is relatively small (e.g., the number of learners N=50).

In summary, these synthetic experiments demonstrate that SPARFA-Trace is capable of accurately estimating both latent learner concept knowledge states and the learner concept knowledge state transition and question parameters.

### 5.2. Predicting Responses for New Learners

We now compare SPARFA-Trace against the KT method described in Pardos and Heffernan (2010) for predicting responses for new learners that do not have previous recorded response history.

Dataset: The dataset we use for this experiment is from an undergraduate computer engineering course collected using OpenStax Tutor (OST) (OpenStaxTutor (2013)). We will refer to this dataset as “Dataset 1” in the following experiments. This dataset comprises the binary-valued graded response from 92 learners answering 203 questions, with 99.5% of the responses observed. Since the KT implementation of Pardos and Heffernan (2010) is unable to handle missing data, we removed learners that do not answer every question from the dataset, resulting in a pruned dataset of 73 learners. The course is organized into three independent sections: The first section is on digital logic, the second on data structures, and the third on basic programming concepts. The full course comprises 11 assessments, including 8 homework assignments and an exam at the end of each section; we assume that the learners' concept knowledge state transitions can only happen between two consecutive assignments/exams, due to their interaction with all the lectures/readings/exercises.

Experimental setup: Since KT is only capable of handling educational datasets that involve a single concept, we partition Dataset 1 into three parts, with each part corresponding to one of the three independent sections. We run KT independently on the three parts, and aggregate the prediction results. (We also ran KT on the entire Dataset 1 without partitioning it into 3 independent sections. The results obtained were inferior to those obtained by running KT on 3 independent sections.) We initialize the four parameters of KT (learner prior, learning probability, guessing probability, slipping probability) with the best initial value we find over 5 different initializations. For SPARFA-Trace, we use K=3, with each concept corresponding to one section of the dataset. In order to alleviate the identifiability issue in our model, we initialize the algorithm with w_{i,k}=1 where question i is in section k and w_{i,k}=1 otherwise. We also initialize the matrices Dₘ with identity matrices I_{3×3}, the vectors dₘ with zero vectors, and covariance matrices Γₘ with identity matrices.

TABLE 1
Comparisons of SPARFA-Trace against knowledge tracing (KT) on
predicting responses for new learners using Dataset 1. SPARFA-Trace
outperforms KT on all three metrics.

| Performance metric | KT | SPARFA-Trace |
|---|---|---|
| Prediction accuracy | 86.42 ± 0.16% | 87.49 ± 0.12% |
| Prediction likelihood | 0.7718 ± 0.0011 | 0.8128 ± 0.0044 |
| Area under the ROC curve | 0.5989 ± 0.0056 | 0.8157 ± 0.0028 |

For cross-validation, we randomly partition Dataset 1 into 5 folds, with each fold consisting of 1/5 of the learners answering all questions. Four folds of the data are used as the training set and the other fold is used as the test set. We train both KT and SPARFA-Trace on the training set and obtain estimates on all learner, learning resource and question-dependent parameters, and test their prediction performances on the test set. For previously unobserved new learners in the test set, both algorithms make the first prediction of Yⱼ^{(t)} at t=1 using question-dependent parameters estimated from the training set. As time goes on, more and more observed responses Yⱼ^{(t)} are available to both algorithms, and they use these responses to make future predictions.

We compare both algorithms on three metrics: prediction accuracy, prediction likelihood, and area under the receiver operation characteristic (ROC) curve. The prediction accuracy corresponds to the percentage of correctly predicted responses; the prediction likelihood corresponds to the average the predicted likelihood of the unobserved responses, i.e.,

$$\frac{1}{\vert {Ω}_{obs}^{c} \vert} {\sum }_{t , j : ( t , j ) ∈ {Ω}_{obs}^{c}}^{ } p ( {Y}_{j}^{( t )} \vert {c}_{j}^{( t )} , {w}_{{i}_{j}^{( t )}} , {μ}_{{i}_{t}^{( t )}} ) ,$$

where Ω_{obs}^{c} is the set of learner responses in the test set; the area under the ROC curve is a commonly-used performance metric for binary classifiers (see Pardos and Heffernan (2010) for details). The area under the ROC curve always is always between 0 and 1, with a larger value representing higher classification accuracy.

Since SPARFA-Trace does not provide point estimates of cⱼ^{(t)} but rather their distributions, we compute the predicted likelihood of unobserved responses by:

$${𝔼}_{{c}_{j}^{( t )}} [ p ( {Y}_{j}^{( t )} \vert {c}_{j}^{( t )} , {w}_{{i}_{j}^{( t )}} , {μ}_{{i}_{j}^{( t )}} ) ] = Φ ( ( 2 {Y}_{j}^{( t )} ) \frac{{w}_{{i}_{j}^{( t )}}^{T} {\hat{m}}_{j}^{( t )} - {μ}_{{i}_{j}^{( t )}}}{\sqrt{1 + {w}_{{i}_{j}^{( t )}}^{T} {\hat{V}}_{j}^{( t )} {w}_{{i}_{j}^{( c )}}}} ) .$$

TABLE 2
Comparisons of SPARFA-Trace against SPARFA-M on predicting
unobserved learner responses for Dataset 1.

| | SPARFA-M | SPARFA-Trace |
|---|---|---|
| Prediction accuracy | 87.10 ± 0.04% | 87.31 ± 0.05% |
| Prediction likelihood | 0.7274 ± 0.0005 | 0.7295 ± 0.0007 |

TABLE 3
Comparisons of SPARFA-Trace against SPARFA-M on predicting
unobserved learner responses for Dataset 2.

| | SPARFA-M | SPARFA-Trace |
|---|---|---|
| Prediction accuracy | 86.64 ± 0.14% | 86.29 ± 0.25% |
| Prediction likelihood | 0.7037 ± 0.0024 | 0.7066 ± 0.0028 |

Results: The means and standard deviations of all three metrics covering multiple cross-validation trials are shown in Table 1. We can see that SPARFA-Trace outperforms KT on all performance metrics for Dataset 1. We also emphasize that SPARFA-Trace is capable of achieving superior prediction performance while simultaneously estimating the quality and content organization parameters of all learning resources and questions.

### 5.3. Predicting Unobserved Learner Responses

It has been shown (Gong et al. (2010)) that collaborative filtering methods often outperform KT in predicting unobserved learner responses, even though they ignore any temporal evolution aspects of the dataset. Hence, we compare SPARFA-Trace against the original SPARFA framework (Lan et al. (2014)), which offers state-of-the-art collaborative filtering performance on predicting unobserved learner responses.

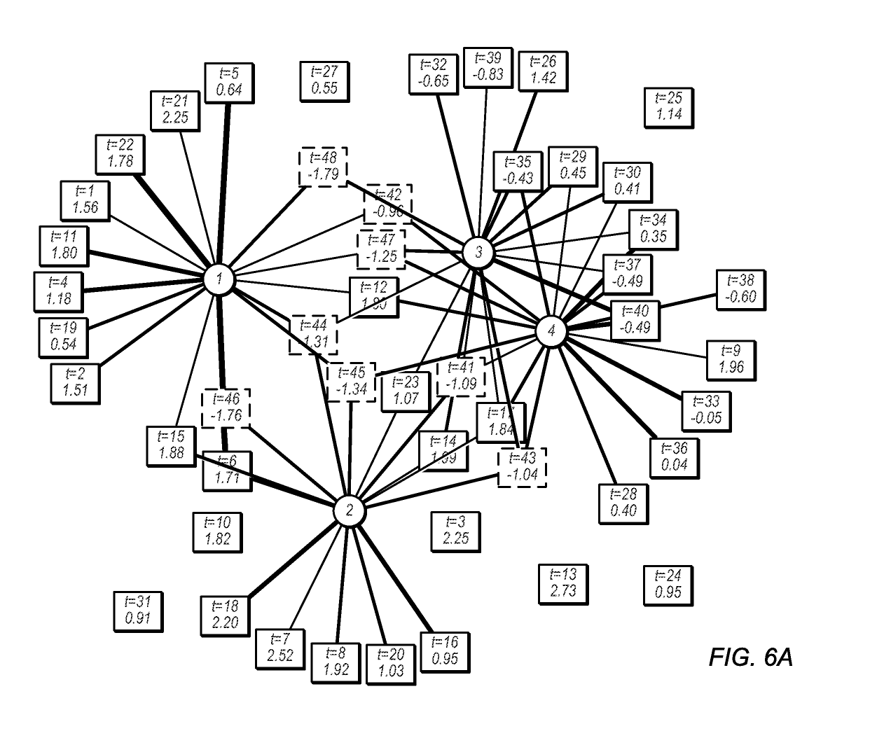

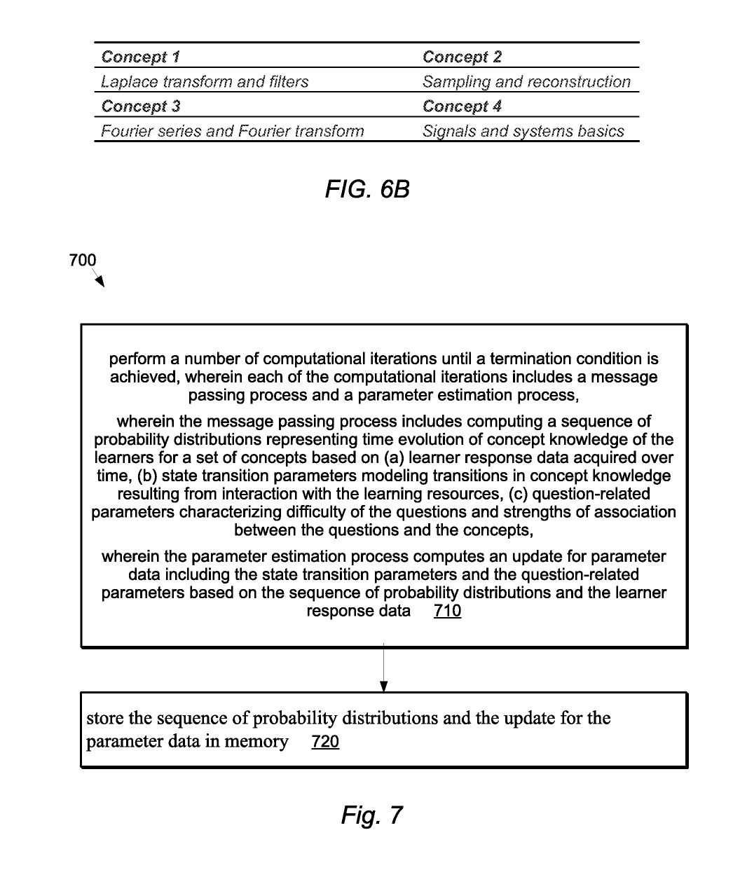

Datasets: We will use two datasets in this experiment. The first dataset is the full Dataset 1 with 92 learners answering 203 questions, explained in Section 5.2. The second dataset we use is from a signals and systems undergraduate course on OST, consisting of 41 learners answering 143 questions, with 97.1% of the responses observed. We will refer to this dataset as “Dataset 2” in the following experiments. All the questions were manually labeled with a number of K=1 concepts, with the concepts being listed in FIG. 6B. The full course comprises 14 assessments, including 12 assignments and 2 exams; we will treat all the lectures/readings/exercises the learners interact with between two consecutive assignments/exams as an learning resource.

Experimental setup: We randomly partition the 143×43 (or 203×92) matrix Y of observed graded learner responses into 5 folds for cross-validation. Four folds of the data are used as the training set and the other fold is used as the test set. We train both the probit variant of SPARFA-M and SPARFA-Trace on the training set to estimate the learner concept knowledge states and the learner, learning resource and question-dependent parameters, and then use these estimates to predict unobserved held-out responses in the test set.

Results: The means and standard deviations of the prediction accuracy and prediction likelihood metrics covering multiple cross-validation trials are shown in Tables 2 and 3. We see that SPARFA-Trace achieves comparable prediction performance to SPARFA-M on both datasets, although the datasets are treated as if they do not have time-varying effects. We emphasize that, in addition to providing competitive prediction performance, SPARFA-Trace is capable of (i) tracing learner concept knowledge evolution over time and (ii) analyzing learning resource and question qualities and their content organization. This extracted information is very important as it allow a PLS to provide timely feedback to learners about their strengths and weaknesses, and to automatically recommend learning resources to learners for remedial studies based on their qualities and contents.

### 5.4. Visualizing Time-Varying Learning and Content Analytics

In this section, we showcase another advantage of SPARFA-Trace over existing KT and collaborative filtering methods, i.e., the visualization of both learner knowledge state evolution over time and the estimated learning resource and question quality and content organization.

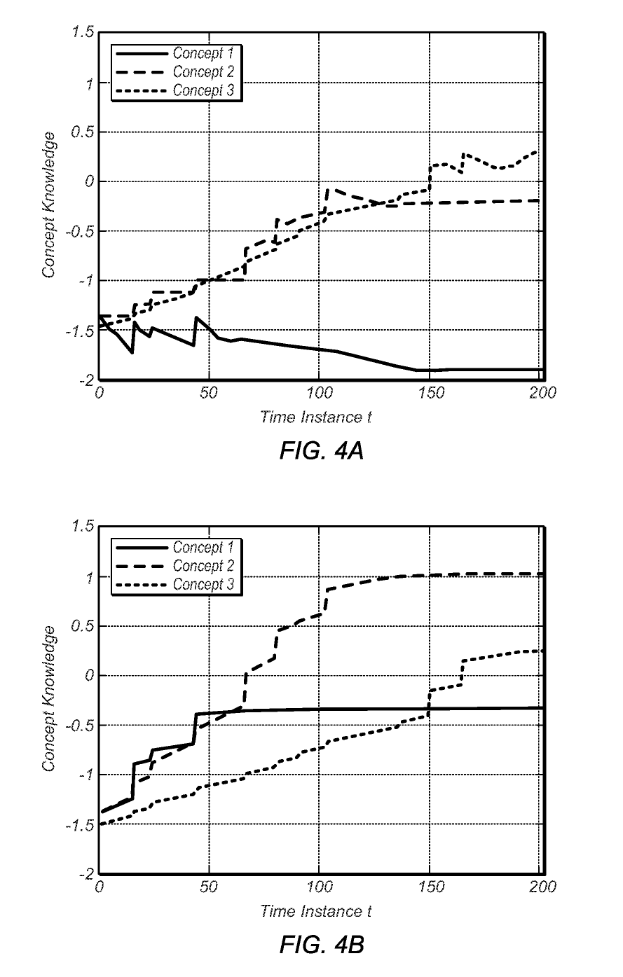

Visualizing learner concept knowledge state evolution: FIG. 4A shows the estimated latent learner concept knowledge states at all time instances for Learner 1 in Dataset 1. We can see that their knowledge on Concepts 2 and 3 gradually improve over time, while their knowledge on Concept 1 does not. Therefore, recommending Learner 1 remedial material on Concept 1 seems necessary, which is verified by the fact that Learner 1 often responds incorrectly on questions covering Concept 1 towards the end of the course.

FIG. 4B shows the average learner concept knowledge states over the entire class at all time instances for Dataset 1. Since Concept 1 is the basic concept that is covered in the early stages of the course, we can see that its mean knowledge among all learners increases in early stages of the course and then remain constant afterwards. In contrast, Concept 3 is the most advanced concept covered near the end of the course, and the improvement in which is not obvious until very late stages of the course. Hence, SPARFA-Trace can enable a PLS to provide timely feedback to individual learners on their concept knowledge at all times, which reveals the learning progress of the learners. SPARFA-Trace can also inform instructors on the trend of the concept knowledge state evolution of the entire class, in order to help them make timely adjustments to their course plans.

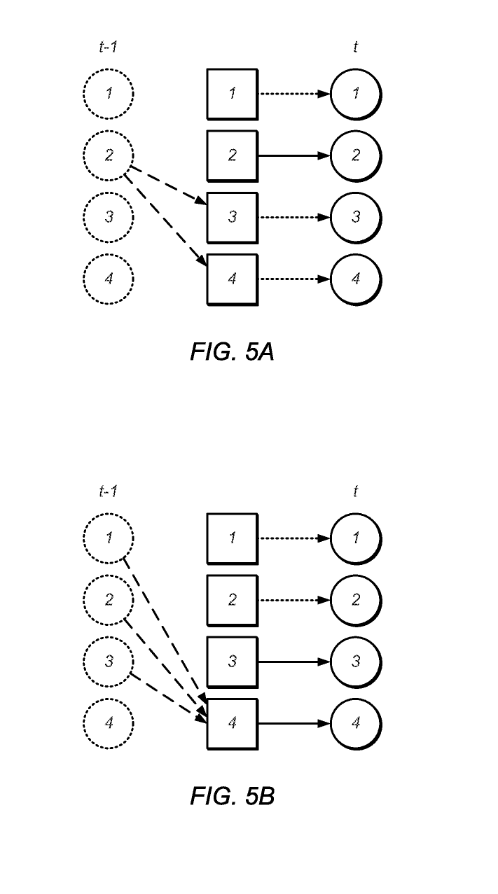

Visualizing learning resource quality and content: FIG. 5A and FIG. 5B show the quality and content organization of learning resources 3 and 9 for Dataset 2. These figures visualize the leaners' concept knowledge state transitions induced by interacting with learning resources 3 and 9. Circular nodes represent concepts; the leftmost set of dashed nodes represent the concept knowledge state vector cⱼ^{(t)}, which are the learners' concept knowledge states before interacting with these learning resources, and the rightmost set of solid nodes represent the concept knowledge state vector cⱼ^{(t)}, which are the learners' concept knowledge states after interacting with these learning resources. Arrows represent the learner concept knowledge state transition matrix Dₘ, the intrinsic quality vector of the learning resource dₘ, and their transformation effects on learners' concept knowledge states. Dotted arrows represent unchanged learner concept knowledge states; these arrows correspond to zero entries in Dₘ and dₘ. Solid arrows represent the intrinsic knowledge gain of some concepts, characterized by large, positive entries in dₘ. Dashed arrows represent the change in knowledge of advanced concepts due to their pre-requisite concepts, characterized by non-zero entries in Dₘ: High knowledge level on pre-requisite concepts can result in improved understanding and an increase on knowledge of advanced concepts, while low knowledge level on these pre-requisite concepts can result in confusion and a decrease on knowledge of advanced concepts.

As shown in FIG. 5A, Learning resource 3 is used in early stage of the course, and we can see that this learning resource gives the learners' a positive knowledge gain of Concept 2, while also helping on the more advanced Concepts 3 and 4. As shown in FIG. 5B, Learning resource 9 is used in later stage of the course, and we can see that it uses the learners' knowledge on all previous concepts to improve their knowledge on Concept 4, while also providing a positive knowledge gain on Concepts 3 and 4.

By analyzing the content organization of learning resources and their effects on learner concept knowledge state transitions, SPARFA-Trace enables a PLS to automatically recommend corresponding learning resources to learners based on their strengths and weaknesses. The estimated learning resource quality information also helps course instructors to distinguish between effective learning resources, and poorly-designed, off-topic, or misleading learning resources, thus helping them to manage these learning resources more easily.

Visualizing question quality and content: FIG. 6A shows the question-concept association graph obtained from Dataset 2. Circle nodes represent concept nodes, while square, box nodes represent question nodes. Each question box is labeled with the time instance at which it is assigned and its estimated intrinsic difficulty. From the graph we can see time-evolving effects, as questions assigned in the early stages of the course cover basic concepts (Concepts 1 and 2), while questions assigned in later stages cover more advanced concepts (Concepts 3 and 4). Some questions are associated with multiple concepts, and they mostly correspond to the final exam questions (boxes with dashed boundaries) where the entire course is covered.

Thus, by estimating the intrinsic difficulty and content organization of each question, SPARFA-Trace allows a PLS to generate feedback to instructors on the underlying knowledge structure of questions, which enables them to identify ill-posed or off-topic questions (such as questions that are not associated to any concepts in FIG. 6A).

### 6. Related Work on Knowledge Tracing for Personalized Learning

Various machine learning algorithms have been designed for personalized learning. Specifically, matrix and tensor factorization approaches have been applied to analyze graded learner responses in order to extract learner ability parameters and/or question-concept relationships. Examples include item response theory (IRT) (Lord (1980); Rasch (1993); Ackerman (1994); Hooker et al. (2009)), and other factor analysis models (Barnes (2005); Linting et al. (2007); Rupp and Templin (2008); Chow et al. (2011a); Lan et al. (2014)). While these methods have shown to provide good prediction performance on unobserved learner responses, they do not take into account the temporal dynamics involved in the process of a course. Therefore, these approaches are only suitable to a static testing scenario, such as the graduate record examinations (GRE), standardized tests, placement exams, etc. (see van der Linden (1998) for details).

A number of approaches have also been developed to analyze temporal learner response data (see, e.g., Corbett and Anderson (1994); Millsap and Meredith (1988); Codd and Cudeck (2013) for details). In particular, knowledge tracing (KT) estimates learner concept knowledge over time, given question-concept mappings and graded binary learner response data. Since such methods all require pre-defined question-concept mappings which are, in general, not available in practice, these methods are labor-intensive to instructors and domain experts, and are not scalable to large-scale applications such as massive online open courses (MOOCs) (see Martin (2012); Knox et al. (2012) for an overview).

Recent approaches to KT without requiring question concept mappings, described in Gonzalez-Brenes and Mostow (2012, 2013) jointly estimate both question-concept (item-skill) mappings and learner concept mastery evolution over time purely from response data. Their method, however, suffers from the following deficiencies: First, Gonzalez-Brenes and Mostow (2012) models the learners' latent concept knowledge as a small number of discrete values and the entire dynamic process for learning is modeled as a hidden Markov model (HMM). Such discrete concept knowledge states do not provide desirable interpretability when the number of discrete learner concept knowledge values is low (the authors used 3 distinct knowledge levels in their paper). In contrary, the proposed SPARFA-Trace framework models learner latent concept knowledge states as continuous random variables, providing finer knowledge representations. Second, Gonzalez-Brenes and Mostow (2012) does not handle questions that involve multiple concepts. In contrast, the proposed SPARFA-Trace framework directly takes into account questions involving multiple concepts in the probabilistic model. Third, Gonzalez-Brenes and Mostow (2012, 2013) introduced a Gibbs sampler approach to infer all of the parameters; such an approach is known to be computationally intensive and, hence, will not scale to large datasets, such as MOOC-sized data. In contrary, the proposed SPARFA-Trace framework uses a computationally efficient EM approach, which is capable of scaling to the MOOC scale.

### 7. Conclusions

We have proposed SPARFA-Trace, a novel, message passing-based approximate Kalman filtering approach for time-varying learning and content analytics. The proposed method jointly traces latent learner concept knowledge and simultaneously estimates the quality and content organization of the corresponding learning resources (such as textbook sections or lecture videos), and the questions in assessment sets. In order to estimate latent learner concept knowledge states at each time instance from observed binary-valued graded learner responses, we have introduced an approximate Kalman filtering framework, given all learner concept knowledge state transition parameters of learning resources and the question-dependent parameters. In order to estimate these parameters, we have introduced novel block multi-convex optimization-based algorithms that estimate all the learner concept knowledge state transition parameters of learning resources and question—concept associations and their intrinsic difficulties. The proposed approach applied to real-world educational datasets has shown its capability of accurately predicting unobserved learner responses, while obtaining interpretable estimates of all learner concept knowledge state transition parameters and question-concept associations.

A PLS can benefit from the information extracted by the SPARFA-Trace framework in a number of ways. Being able to trace learners' concept knowledge enables a PLS to make timely feedback to learners on their strengths and weaknesses. Meanwhile, this information will also enable adaptivity in designing personalized learning pathways in real time, as instructors can recommend different actions for different learners to take, based on their individual concept knowledge states. Furthermore, the estimated content-dependent parameters provide rich information on the knowledge structure and quality of learning resources. This capacity is crucial for a PLS to automatically suggest learning resources to learners for remedial studies. Together with the question parameters estimated, a PLS would be able to operate in an autonomous manner, requiring only minimal human input and intervention; this paves the way of applying SPARFA-Trace to MOOC-scale education scenarios, where the massive amount of data precludes manual intervention.

We end with a number of avenues for future research. For example, more accurate message-passing schemes like expectation propagation (Qi (2004)) could be applied to improve the performance and accuracy of SPARFA-Trace. More sophisticated non-affine learner concept knowledge state transition models can also be applied, in contrast to the affine model proposed in Section 2.2. In order to provide better interpretation to the estimated learner concept knowledge state transition and question parameters, tagging and question text information can be coupled with SPARFA-Trace (see Lan et al. (2013a,b) for corresponding extensions to SPARFA that mine question tags and question text information). It is worth mentioning that SPARFA-Trace has potential to be applied to a wide range of other datasets, including (but not necessarily limited to) the analysis of temporal evolution in legislative voting data (Wang et al. (2013)), and the study of temporal effects in general collaborative filtering settings (Silva and Carin (2012)). The extension of SPARFA-Trace to such applications is part of an on-going work.

### Extensions to SPARFA-Trace

In the following numbered paragraphs, we discuss several extensions to SPARFA-Trace. For simplicity, we drop the learner index j, as these methods apply to all learners. Likewise, we drop the learning resource index m and the question index i.

1. Tagging as Support Information. Recall that the concept knowledge vectors c^{(t)} are K×1-dimensional variables, and each entry corresponds to a concept (a total of K concepts). Correspondingly, the w vectors and d vectors are also K×1, and the D and Gamma matrices are K×K. The problem of estimating all these parameters from only binary-valued observations Y is a challenging and underdetermined problem, since there are a lot of parameters with not many observations. In practice, a simple way of reducing the number of parameters is to obtain a set of tags on the questions and learning resources from a domain expert/course instructor, so that each tag corresponds to a (predefined) concept. (The one or more tags that are assigned to a given question or learning resource identify the one or more concepts involved in that question or learning resource.) Then, we can simply use these tags to identify the support set of w, D and d—only the entries in these variables corresponding to the concepts identified by the assigned tags are active, while the others are all zero. We only need to estimate the values of these entries. In this way, we make good use of the expert human opinion on these learning resources and simultaneously reduce the total number of parameters, making the problem easier to solve. Furthermore, the 11-norm regularizer can be omitted, which further speeds up the algorithm.

2. Time-period Length Information. Instead of simply recording the actions learners perform, we can also record the amount of time they spend on a piece of learning resource or the amount of time between assessments. In this way, we can estimate interesting cognitive parameters. As an example, consider the forgetting effect

c^{(t)}c^{(t-1)}−gamma*tau+noise,

which models the forgetting effect as a linear decay in time. Here, gamma represents the rate of forgetting and tau represents the amount of time between assessments t and t−1. Utilizing tau, we can estimate the forgetting rate parameter gamma, which can be very useful for cognitive science applications.

3. Simple Scheduler. With SPARFA-Trace, one can estimate all the c, w, μ, D, d, Γ parameters. However, the SPARFA-Trace method does not offer a decision rule, i.e., a recommendation algorithm to compute the “optimal” next action for each learner, at current time instant t. A straightforward way of doing so is to simply pick the next action A that maximizes expectation of p(c^{(t+1)}|c^{(t)}, A), i.e., pick the next action that on average brings the learner to the best knowledge state. This action can either be studying a learning resource or answering a question, and the expectation is over the possible learning outcomes (randomness of the state transition for studying a learning resource or randomness of the response for answering a question).

4. Alternative State Transition/Observation Model. In some of the above-described embodiments, we restrict SPARFA-Trace to take binary-valued observations. However, we can easily extend the framework to handle discrete-valued or real-valued responses (ordinal or categorical, or Gaussian observations). On the other hand, the state transition model can also vary. For example, we might further simplify the model by setting D=0, i.e., c^{(t)}=c^{(t-1)}+d+noise, meaning that the state transition is simply a DC addition. Alternatively, we can also introduce nonlinear models on p(ĉ(t) ĉ(t−1)) to handle more complicated cognitive dynamics, which may require using a particle filtering algorithm instead of the approximate Kalman filtering algorithm described above.

### REFERENCES

T. A. Ackerman. Using multidimensional item response theory to understand what items and tests are measuring. Applied Measurement in Education, 7(4):255-278, October 1994.
T. Barnes. The Q-matrix method: Mining student response data for knowledge. In Proc. AAAI Workshop Educational Data Mining, pages 1-8, July 2005.
A. Beck and M. Teboulle. A fast iterative shrinkage-thresholding algorithm for linear inverse problems. SIAM Journal on Imaging Science, 2(1):183-202, March 2009.
C. M. Bishop and N. M. Nasrabadi. Pattern recognition and machine learning Springer New York, 2006.
A. C. Butler, E. J. Marsh, J. P. Slavinsky, and R. G. Baraniuk. Integrating cognitive science and technology improve learning in a STEM classroom. Educational Psychology Review, 26(1), February 2014.
M. Carrier and H. Pashler. The inuence of retrieval on retention. Memory & Cognition, 20(6):633-642, November 1992.
S. Chow, N. Tang, Y. Yuan, X. Song, and H. Zhu. Bayesian estimation of semiparametric nonlinear dynamic factor analysis models using the Dirichlet process prior. British Journal of Mathematical and Statistical Psychology, 64(1):69-106, February 2011a.
S. Chow, J. Zu, K. Shifren, and G. Zhang. Dynamic factor analysis models with time-varying parameters. Multivariate Behavioral Research, 46(2):303-339, April 2011b.
C. L. Codd and R. Cudeck. Nonlinear random-effects mixture models for repeated measures. Psychometrika, 78(4):1-24, December 2013.
A. T. Corbett and J. R. Anderson. Knowledge tracing: Modeling the acquisition of procedural knowledge. User modeling and user-adapted interaction, 4(4):253-278, December 1994.
A. Doucet, N. De Freitas, K. Murphy, and S. Russell. Rao-Blackwellised particle filtering for dynamic Bayesian networks. In Proc. 16th Conf. on Uncertainty in Artificial Intelligence, pages 176-183, June 2000.
D. B. Dunson. Dynamic latent trait models for multidimensional longitudinal data.
Journal of the American Statistical Association, 98(463):555-563, December 2003.
G. A. Einicke and L. B. White. Robust extended Kalman filtering. IEEE Trans. on Signal Processing, 47(9):2596-2599, September 1999.
C. G. Forero and A. Maydeu-Olivares. Estimation of IRT graded response models: limited versus full information methods. Psychological methods, 14(3):275-299, September 2009.
K. Fronczyk, A. E. Waters, M. Guindani, R. G. Baraniuk, and M. Vannucci. A Bayesian infinite factor model for learning and content analytics. Computational Statistics and Data Analysis, June 2013, submitted.
Y. Gong, J. E. Beck, and N. T. Heffernan. Comparing knowledge tracing and performance factor analysis by using multiple model fitting procedures. In Intelligent Tutoring Systems, pages 35-44, June 2010.
J. P. Gonzalez-Brenes and J. Mostow. Dynamic cognitive tracing: Towards unified discovery of student and cognitive models. In Proc. 5th Intl. Conf. on Educational Data Mining, pages 49-56, June 2012.
J. P. Gonzalez-Brenes and J. Mostow. What and when do students learn? Fully data-driven joint estimation of cognitive and student models. In Proc. 6th Intl. Conf. on Educational Data Mining, pages 236-239, July 2013.
H. H. Harman. Modern Factor Analysis. University of Chicago Press, 1976.
T. Hastie, R. Tibshirani, and J. Friedman. The Elements of Statistical Learning Springer, 2010.
S. S. Haykin. Kalman filtering and neural networks. Wiley Online Library, 2001.
G. Hooker, M. Finkelman, and A. Schwartzman. Paradoxical results in multidimensional item response theory. Psychometrika, 74(3):419-442, September 2009.
R. A. Horn and C. R. Johnson. Topics in Matrix Analysis. Cambridge University Press, 1991.
E. H. Ip and S. Chen. Projective item response model for test-independent measurement. Applied Psychological Measurement, 36(7):581-601, October 2012.
A. H. Jazwinski. Stochastic Processes and Filtering Theory. Academic Press, New York, 1970.
S. J. Julier and J. K. Uhlmann. New extension of the Kalman filter to nonlinear systems. In AeroSense '97: The 11th International Symposium on Aerospace/Defense Sensing, Simulation and Controls, pages 182-193, April 1997.
R. E. Kalman. A new approach to linear filtering and prediction problems. ASME Journal of basic Engineering, 82(1):35-45, 1960.
Knewton adaptive learning: Building the world's most powerful recommendation engine for education, June 2012, at the Knewton dot com website.
J. Knox, S. Bayne, H. MacLeod, J. Ross, and C. Sinclair. MOOC pedagogy: the challenges of developing for coursera. Online Newsletter of the Association for Learning Technologies, August 2012.
F. R. Kschischang, B. J. Frey, and H. A. Loeliger. Factor graphs and the sum-product algorithm. IEEE Trans. on Information Theory, 47(2):498-519, February 2001.
A. S. Lan, C. Studer, A. E. Waters, and R. G. Baraniuk. Tag-aware ordinal sparse factor analysis for learning and content analytics. In Proc. 6th Intl. Conf. on Educational Data Mining, pages 90-97, July 2013a.
A. S. Lan, C. Studer, A. E. Waters, and R. G. Baraniuk. Joint topic modeling and factor analysis of textual information and graded response data. In Proc. 6th Intl. Conf. on Educational Data Mining, pages 324-325, July 2013b.
A. S. Lan, A. E. Waters, C. Studer, and R. G. Baraniuk. Sparse factor analysis for learning and content analytics. Journal of Machine Learning Research, June 2014.
M. Linting, J. J. Meulman, P. Groenen, and A. J. van der Koojj. Nonlinear principal components analysis: introduction and application. Psychological methods, 12(3):336, September 2007.
H. A. Loeliger. An introduction to factor graphs. IEEE Signal Processing Magazine, 21(1): 28-41, January 2004.
F. M. Lord. Applications of Item Response Theory to Practical Testing Problems. Erlbaum Associates, 1980.
F. G. Martin. Will massive open online courses change how we teach? Communications of the ACM, 55(8):26-28, August 2012.
P. S. Maybeck. Stochastic Models, Estimation and Control, Vol. 1. Academic Press, New York, 1979.
R. E. Millsap and W. Meredith. Component analysis in cross-sectional and longitudinal data. Psychometrika, 53(1):123-134, March 1988.
T. P. Minka. Expectation propagation for approximate Bayesian inference. In Proceedings of the 17th conference on Uncertainty in Artificial Intelligence, pages 362-369, August 2001.
T. P. Minka. From hidden Markov models to linear dynamical systems. Technical Report 531, Vision and Modeling Group of Media Lab, MIT, 1999.
Openstax tutor at the OpenStaxTutor Website, September 2013.
Z. A. Pardos and N. T. Heffernan. Modeling individualization in a Bayesian networks implementation of knowledge tracing. In Proc. 18th Intl. Conf. on User Modeling, Adaptation, and Personalization, pages 255-266, June 2010.
Y. Qi. Extending expectation propagation for graphical models. PhD thesis, Massachusetts Institute of Technology, October 2004.
G. Rasch. Probabilistic Models for Some Intelligence and Attainment Tests. MESA Press, 1993.
C. E. Rasmussen and C. K. I. Williams. Gaussian Process for Machine Learning. MIT Press, 2006.
S. Roweis and Z. Ghahramani. Learning nonlinear dynamical systems using the Expectation-maximization algorithm. Kalman filtering and neural networks, 6:175-220, 2001.
A. A. Rupp and J. Templin. The effects of Q-matrix misspecification on parameter estimates and classification accuracy in the DINA model. Educational and Psychological Measurement, 68(1):78-96, February 2008.
A. M. Sanjeev, S. Maskell, N. Gordon, and T. Clapp. A tutorial on particle filters for online nonlinear/non-Gaussian Bayesian tracking. IEEE Transactions on Signal Processing, 50(2):174-188, January 2002.
J. Silva and L. Carin. Active learning for online Bayesian matrix factorization. In Proc. 18th ACM SIGKDD Intl. Conf. on Knowledge discovery and data mining, pages 325-333, August 2012.
C. E. Stevenson, M. Hickendorff, W. Resing, W. J. Heiser, and P. de Boeck. Explanatory item response modeling of children's change on a dynamic test of analogical reasoning. Intelligence, 41(3):157-168, May 2013.
J. L. Templin and R. A. Henson. Measurement of psychological disorders using cognitive diagnosis models. Psychological Methods, 11(3):287, September 2006.
W. J. van der Linden. Bayesian item selection criteria for adaptive testing. Psychometrika, 63(2):201-216, June 1998.
K. VanLehn, C. Lynch, K. Schulze, J. A. Shapiro, R. Shelby, L. Taylor, D. Treacy, A. Weinstein, and M. Wintersgill. The Andes physics tutoring system: Lessons learned. Intl. Journal of Artificial Intelligence in Education, 15(3):147-204, 2005.
E. A. Wan and R. Van Der Merwe. The unscented Kalman filter for nonlinear estimation. In Adaptive Systems for Signal Processing, Communications, and Control Symposium, pages 153-158, October 2000.
E. Wang, E. Salazar, D. Dunson, and L. Carin. Spatio-temporal modeling of legislation and votes. Bayesian Analysis, 8(1):233-268, March 2013.
B. Weiner and H. Reed. Effects of the instructional sets to remember and to forget on short-term retention: Studies of rehearsal control and retrieval inhibition (repression). Journal of Experimental Psychology, 79(2):226, February 1969.
R. Wolfinger. Laplace's approximation for nonlinear mixed models. Biometrika, 80(4): 791-795, December 1993.

### Method 700

In one set of embodiments, a method 700 may include the operations shown in FIG. 7. (The method 700 may also include any subset of the features, elements and embodiments described above.) The method 700 may be used for tracing variation of concept knowledge of learners over time and evaluating content organization of learning resources used by the learners. It should be understood that various embodiments of method 700 are contemplated, e.g., embodiments in which the illustrated operations are performed in different orders, embodiments in which one or more of the illustrated operations are omitted, embodiments in which the illustrated operations are augmented with one or more additional operations, embodiments in which one or more of the illustrated operations are parallelized, etc. The method 700 may be implemented by a computer system (or more generally, by a set of one or more computer systems). In some embodiments, the computer system may be operated by an educational service provider, e.g., an Internet-based educational service provider.

At 710, the computer system may perform a number of computational iterations until a termination condition is achieved, wherein each of the computational iterations includes a message passing process and a parameter estimation process. Any of a wide variety of terminal conditions may be used.

The message passing process may include computing a sequence of probability distributions representing time evolution of concept knowledge of the learners for a set of concepts based on (a) learner response data acquired over time, (b) state transition parameters modeling transitions in concept knowledge resulting from interaction with the learning resources, (c) question-related parameters characterizing difficulty of the questions and strengths of association between the questions and the concepts. The learner response data is data that is usable to estimate the extent of concept knowledge of the learners. For example, the learner response data may include one or more of the following: (a) graded answers to questions posed to the learners over time, (b) categorical responses to questions posed to the learners over time, (c) records of class activity or participation of learners over time. (A categorical response may be a response that indicates a selection from a set of categories. For example, an answer to a multiple-choice question is a kind of categorical response.) In one embodiment, the learner response data includes only graded answers to questions posed to the learners over time.

The parameter estimation process may compute an update for parameter data including the state transition parameters and the question-related parameters based on the sequence of probability distributions and the learner response data.

At 720, the computer system may store the sequence of probability distributions and the update for the parameter data in memory.

The concept knowledge may be represented by a vector, where each of the components of the vector represents extent of knowledge of a corresponding concept from the set of concepts.

The learning resources may include any of a wide variety of resources that are believed to be conducive to the acquisition of concept knowledge. For example, the learning resources may include one or more of the following types of resources: texbooks, videos, computer simulation tools, interaction time with tutors or experts or instructors, interaction time with physical objects or machines exemplifying targeted concepts, access to geographical locations, access to historical sites, and visits to archaeological sites representing targeted concepts.

In some embodiments, the method 700 also includes displaying one or more of the probability distributions or statistical parameters derived from the one or more probably distributions using a display device. For example, a learner may access the computer system to view statistical parameters such as means values and/or standard deviations of his/her concept knowledge for one or more or all concepts over time (or at the current time or at a specified value of time.)

In some embodiments, the method 700 may also include transmitting a message to a given one of the learners (e.g., through a computer network such as the Internet), wherein the message includes: one or more of the probability distributions corresponding to the given learner, or statistical parameters derived from the one or more probably distributions.

In some embodiments, each question i of said questions has a corresponding set Sᵢ of one or more tags indicating one or more of the concepts that are associated with the question, wherein each learning resource m of said learning resources has a corresponding set Sₘ of one or more tags indicating one or more of the concepts that are associated with the learning resource m. In these embodiments, the parameter estimation process includes restricting support of the state transition parameters and support of said questions related parameters based on said tag sets Sᵢ and said tag sets Sₘ.

In some embodiments, the method 700 may also include, for a given one of the learners: (a) selecting a learning resource from the set of learning resources by maximizing an expectation of a conditional probability p(c^{(t+1)}|c^{(t)},m) over learning resource index m, wherein c^{(t)} represents concept knowledge at the current time instant, wherein c^{(t+1)} represents concept knowledge at a future time instant; and (b) transmitting or displaying a message to the given learner indicating the selected learning resource as a recommendation for further study.

In one set of embodiments, the method 700 also includes, for a given one of the learners: (a) selecting a question from a set of questions by maximizing an expectation of a conditional probability p(c^{(t+1)}|c^{(t)},i) over the set of questions, wherein i is an index to the set of questions, wherein c^{(t)} represents concept knowledge at the current time instant, wherein c^{(t+1)} represents concept knowledge at a future time instant; and (b) transmitting or displaying a message to the given learner indicating the selected question as a recommendation for further study.

In some embodiments, the method 700 may also include, for a given one of the learners, transmitting a message to the learner indicating an extent of the learner's concept knowledge for concepts in the set of concepts.

In one set of embodiments, a non-transitory memory medium stores program instructions for tracing variation of concept knowledge of learners over time and evaluating content organization of learning resources used by the learners. The program instructions, when executed by a computer system, cause the computer system to implement the following operations. (The program instructions may also cause the computer system to implement any subset of the features, elements and embodiments described above.)

The computer system may perform a number of computational iterations until a termination condition is achieved, wherein each of the computational iterations includes a message passing process and a parameter estimation process,

The message passing process may include computing a sequence of probability distributions representing time evolution of concept knowledge of the learners for a set of concepts based on (a) learner response data acquired over time, (b) state transition parameters modeling transitions in concept knowledge resulting from interaction with the learning resources, (c) question-related parameters characterizing difficulty of the questions and strengths of association between the questions and the concepts.

The parameter estimation process may compute an update for parameter data including the state transition parameters and the question-related parameters based on the sequence of probability distributions and the learner response data.

The computer system may store the sequence of probability distributions and the update for the parameter data in memory.

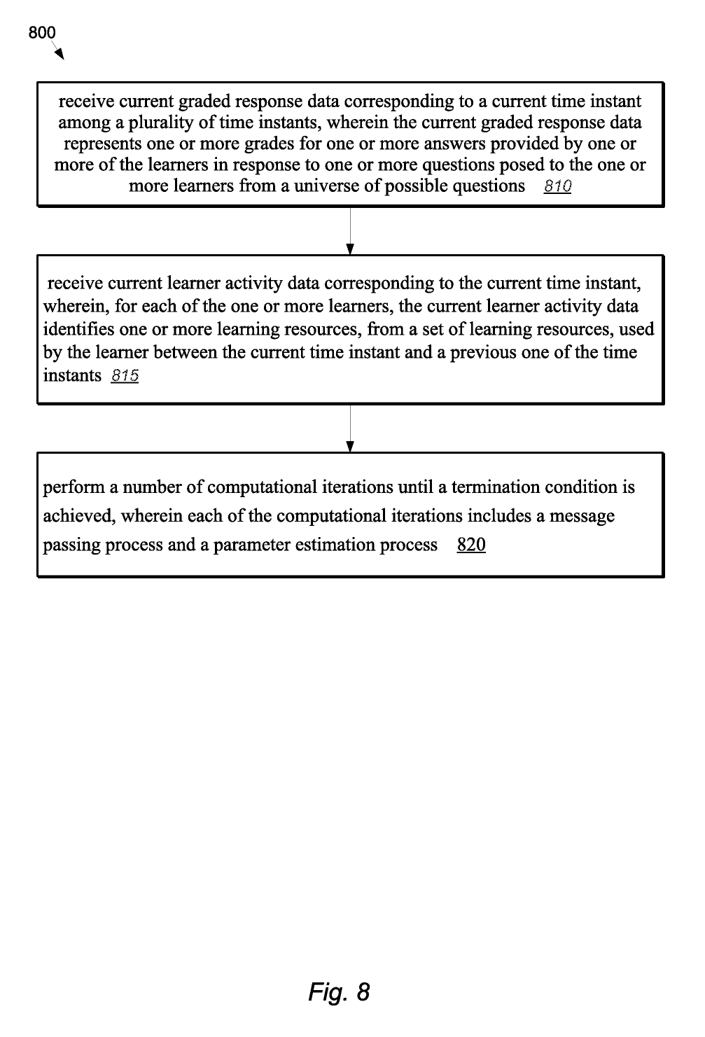

In one set of embodiments, a method 800 may include the operations shown in FIG. 8. (The method 800 may also include any subset of the features, elements and embodiments described above.) The method 800 may be used for tracing variation of concept knowledge of learners over time and evaluating content organization of learning resources used by the learners. It should be understood that various embodiments of method 800 are contemplated, e.g., embodiments in which the illustrated operations are performed in different orders, embodiments in which one or more of the illustrated operations are omitted, embodiments in which the illustrated operations are augmented with one or more additional operations, embodiments in which one or more of the illustrated operations are parallelized, etc. The method 800 may be implemented by a computer system (or more generally, by a set of one or more computer systems). In some embodiments, the computer system may be operated by an educational service provider, e.g., an Internet-based educational service provider.

At 810, the computer system may receive current graded response data corresponding to a current time instant among a plurality of time instants, wherein the current graded response data represents one or more grades for one or more answers provided by one or more of the learners in response to one or more questions posed to the one or more learners from a universe of possible questions.

At 815, the computer system may receive current learner activity data corresponding to the current time instant, wherein, for each of the one or more learners, the current learner activity data identifies one or more learning resources, from a set of learning resources, used by the learner between the current time instant and a previous one of the time instants.

At 820, the computer system may perform a number of computational iterations until a termination condition is achieved, wherein each of the computational iterations includes a message passing process and a parameter estimation process.

The message passing process may include computing probability distributions, wherein, for each of the one or more learners and each of the time instants, a corresponding one of the probability distributions represents concept knowledge of the learner with respect to a set of concepts at the time instant, wherein said computing the probability distributions is based on input data comprising: (a) the current graded response data; (b) previously-accumulated graded response data corresponding to time instants prior to the current time instant; (c) the current learner activity data; (d) previously-accumulated learner activity data corresponding to transitions between successive pairs of the prior time instants; (d) for each of the one or more learning resources, state transition parameters that characterize a model of random transition of the concept knowledge as a result of learner interaction with the learning resource; (e) for each of the one or more questions, association parameters characterizing strengths of association between said question and concepts in the set of concepts.

The parameter estimation process may include computing an update for parameter data including the state transition parameters and the association parameters based on the probability distributions, the current graded response data, the previously-accumulated graded response data, the current learner activity data and previously-accumulated learner activity data, wherein said computing the update includes optimizing an objective function over a multi-dimensional space corresponding to the state transition parameters and the association parameters.

After the termination condition has been achieved, the computer system may store the probability distributions, the state transition parameters and the association parameters in memory.

In some embodiments, the input data also includes, for each of the one or more questions, an estimated difficulty of the question.

In some embodiments, each of the one or more grades is selected from a universe of two or more possible grade values. In one embodiment, the grades are binary-valued. Thus, the universe includes only two elements (such as True or False).

In some embodiments, the model of the random state transition is an affine model. However, in other embodiments, it may be a non-linear model.

In some embodiments, the concept knowledge is represented by a vector, wherein each of the components of the vector represents an extent of knowledge of a corresponding concept from the set of concepts.

In some embodiments, the action of optimizing the objective function includes independently optimizing a plurality of subspace objective functions over respective subspaces of the multi-dimensional space, e.g., as variously described above.

In some embodiments, the plurality of subspace objective functions includes a subspace objective function for each of the learning resources and a subspace objective function for each of the questions. (See the problems Pd and Pw described above.)

In some embodiments, the subspace objective function for learning resource m is a sum of terms Gₘ(t,j) over time-learner pairs (t,j) such that learner j interacted with learning resource m between time instant t−1 and time instant t, wherein the term Gₘ(t,j) is a sum of (a) an expectation of a negative log likelihood of concept knowledge of learner j at time instant t conditioned upon concept knowledge of learner j at time instant t−1 and the state transition parameters associated with the learning resource m and (b) a sparsifying term enforcing sparsity on at least a subset of the state transition parameters associated with the learning resource m.

In some embodiments, the sub-objective function for each question i is a sum of terms Hᵢ(t,j) over time-learner pairs (t,j) such that learner j answered question i at time instant t, wherein the term Hᵢ(t,j) is a sum of (a) an expectation of a negative log likelihood of a grade achieved by the learner j on question i at time t conditioned upon concept knowledge of the learner j at time t and the association parameters for question i.

In some embodiments, the state transition parameters for learning resource m is of the form c^{(t)}=(I+Dₘ)c^{(t-1)}+dₘ+ε^{(t-1)}, wherein vector c(t) represents concept knowledge at time instant t, wherein c^{(t-1)} represents concept knowledge at time instant t+1, wherein the state transition parameters for learning resource m include matrix Dₘ, vector dₘ and matrix Fₘ, wherein matrix Γₘ is a covariance matrix characterizing zero-mean random noise vector ε^{(t-1)}.

In some embodiments, components of the vector dₘ represent effectiveness of the learning resource m for inducing changes in a corresponding one of the concepts, wherein the set of operations includes transmitting a message to an instructor or a learner or an author of the learning resource m, wherein the message includes the vector dₘ.

In some embodiments, the matrix Dₘ for learning resource m is constrained during said optimization to be sparse and lower triangular, wherein each non-zero element of the matrix Dₘ represents a corresponding prerequisite relationship between a corresponding pair of the concepts and a strength of the prerequisite relationship, wherein the set of operations includes displaying a graphical representation of the prerequisite relationships and their strengths based on the matrix Dₘ.

In some embodiments, the method 800 also includes displaying (e.g., by transmitting information to enable displaying or viewing at a client computer) one or more of the probability distributions or statistical parameters derived from the one or more probably distributions using a display device.

In some embodiments, the method 800 also includes transmitting a message to a given one of the one or more learners, wherein the message includes one or more of the probability distributions corresponding to the given learner.

In some embodiments, the method 800 also includes, for a given one of the one or more learners: (a) selecting a learning resource from the set of learning resources by maximizing an expectation of a conditional probability p(c^{(t+1)}|c^{(t)},m) over learning resource index m, wherein c^{(t)} represents concept knowledge at the current time instant, wherein c^{(t+1)} represents concept knowledge at a future time instant; and (b) transmitting a message to the given learner indicating the selected learning resource as a recommendation for further study.

In some embodiments, the method 800 also includes, for a given one of the one or more learners, transmitting a message to the learner indicating an extent of the learner's concept knowledge for concepts in the set of concepts.

In some embodiments, the message passing process includes a forward subprocess and a backward subprocess. The forward subprocess may recursively compute, for each time index t=1, 2, . . . , T, an estimate for probability distribution p(c^{(t)}|y⁽¹⁾, . . . , y^{(t)}) based on probability distribution p(c^{(t-1)}|y⁽¹⁾, . . . , y^{(t-1)}), probability distribution p(c^{(t)}|c^{(t-1)}) and probability distribution p(y(t),c(t)), wherein c^{(t)} represents concept knowledge at time instant t, wherein c^{(t-1)} represents concept knowledge at time instant t−1, wherein y^{(u)} represents a grade for a given learner at time instant u, wherein T is the current time index. The backward subprocess may recursively compute, for each time index t=T, (T−1), (T−2), . . . , 2, 1, an estimate for probability distribution p(c^{(t-1)}|y⁽¹⁾, . . . , (y^{(T)}) based on probability distribution p(c^{(t)}|y⁽¹⁾, . . . , y^{(T)}), probability distribution p(c^{(t)}|c^{(t-1)}) and probability distribution p(y(t),c(t)).

In some embodiments, the computation of the estimate for probability distribution p(c^{(t)}|y⁽¹⁾, . . . , y^{(t)}) includes approximating the probability distribution p(c^{(t)}|y⁽¹⁾, . . . , y^{(t)}) with a Gaussian distribution.

Computer System

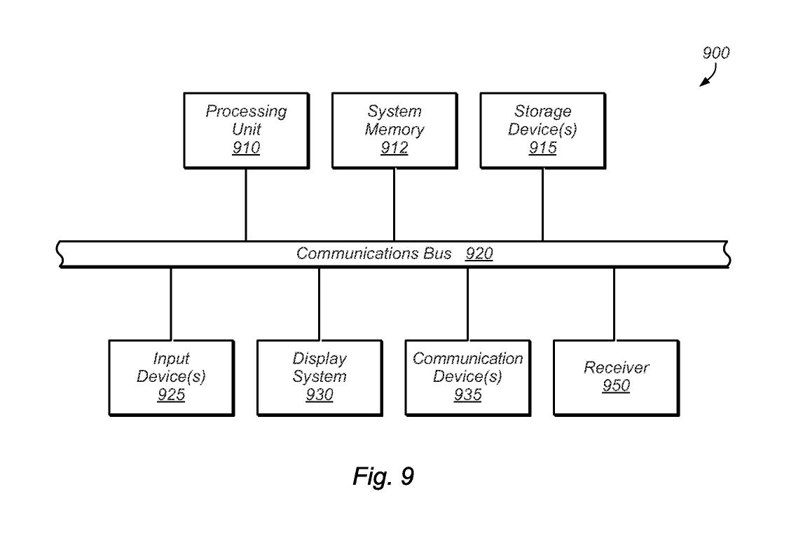

FIG. 9 illustrates one embodiment of a computer system 900 that may be used to perform any of the method embodiments described herein, or, any combination of the method embodiments described herein, or any subset of any of the method embodiments described herein, or, any combination of such subsets.

Computer system 900 may include a processing unit 910, a system memory 912, a set 915 of one or more storage devices, a communication bus 920, a set 925 of input devices, and a display system 930.

System memory 912 may include a set of semiconductor devices such as RAM devices (and perhaps also a set of ROM devices).

Storage devices 915 may include any of various storage devices such as one or more memory media and/or memory access devices. For example, storage devices 915 may include devices such as a CD/DVD-ROM drive, a hard disk, a magnetic disk drive, magnetic tape drives, etc.

Processing unit 910 is configured to read and execute program instructions, e.g., program instructions stored in system memory 912 and/or on one or more of the storage devices 915. Processing unit 910 may couple to system memory 912 through communication bus 920 (or through a system of interconnected busses, or through a network). The program instructions configure the computer system 900 to implement a method, e.g., any of the method embodiments described herein, or, any combination of the method embodiments described herein, or, any subset of any of the method embodiments described herein, or any combination of such subsets.

Processing unit 910 may include one or more processors (e.g., microprocessors).

One or more users may supply input to the computer system 100 through the input devices 925. Input devices 925 may include devices such as a keyboard, a mouse, a touch-sensitive pad, a touch-sensitive screen, a drawing pad, a track ball, a light pen, a data glove, eye orientation and/or head orientation sensors, a microphone (or set of microphones), or any combination thereof.

The display system 930 may include any of a wide variety of display devices representing any of a wide variety of display technologies. For example, the display system may be a computer monitor, a head-mounted display, a projector system, a volumetric display, or a combination thereof. In some embodiments, the display system may include a plurality of display devices. In one embodiment, the display system may include a printer and/or a plotter.

In some embodiments, the computer system 900 may include other devices, e.g., devices such as one or more graphics accelerators, one or more speakers, a sound card, a video camera and a video card, a data acquisition system.

In some embodiments, computer system 900 may include one or more communication devices 935, e.g., a network interface card for interfacing with a computer network (e.g., the Internet). As another example, the communication device 935 may include one or more specialized interfaces for communication via any of a variety of established communication standards or protocols.

The computer system may be configured with a software infrastructure including an operating system, and perhaps also, one or more graphics APIs (such as OpenGL®, Direct3D, Java 3D™)

Any of the various embodiments described herein may be realized in any of various forms, e.g., as a computer-implemented method, as a computer-readable memory medium, as a computer system, etc. A system may be realized by one or more custom-designed hardware devices such as ASICs, by one or more programmable hardware elements such as FPGAs, by one or more processors executing stored program instructions, or by any combination of the foregoing.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a mobile device, a wearable computer, a computer embedded in a living organism, etc.

Any of the various embodiments described herein may be combined to form composite embodiments. Furthermore, any of the various features, embodiments and elements described in U.S. Provisional Application No. 61/917,856 (filed Dec. 18, 2013) may be combined with any of the various embodiments described herein to form composite embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for tracing variation of concept knowledge of learners over time and evaluating content organization of learning resources used by the learners, the method comprising:
performing a set of operations using a computer system, wherein the set of operations includes:
performing a number of computational iterations until a termination condition is achieved, wherein each of the computational iterations includes a message passing process and a parameter estimation process,
wherein the message passing process includes computing a sequence of probability distributions representing time evolution of concept knowledge of the learners for a set of concepts based on (a) learner response data acquired over time, (b) state transition parameters modeling transitions in concept knowledge resulting from interaction with the learning resources, (c) question-related parameters characterizing difficulty of the questions and strengths of association between the questions and the concepts;
wherein the parameter estimation process computes an update for parameter data including the state transition parameters and the question-related parameters based on the sequence of probability distributions and the learner response data;
storing the sequence of probability distributions and the update for the parameter data in memory.

2. The method of claim 1, wherein the concept knowledge is a vector, wherein each of the components of the vector represents extent of knowledge of a corresponding concept from the set of concepts.

3. The method of claim 1, wherein the set of operations also includes displaying one or more of the probability distributions or statistical parameters derived from the one or more probably distributions using a display device.

4. The method of claim 1, wherein the set of operations also includes transmitting a message to a given one of the learners, wherein the message includes:
one or more of the probability distributions corresponding to the given learner,
or statistical parameters derived from the one or more probably distributions.

5. The method of claim 1, wherein the set of operations also includes, for a given one of the learners:
selecting a learning resource from the set of learning resources by maximizing an expectation of a conditional probability p(c^{(t+1)}|c^{(t)},m) over learning resource index m, wherein c^{(t)} represents concept knowledge at the current time instant, wherein c^{(t+1)} represents concept knowledge at a future time instant;
transmitting a message to the given learner indicating the selected learning resource as a recommendation for further study.

6. The method of claim 1, wherein the set of operations also includes, for a given one of the learners, transmitting a message to the learner indicating an extent of the learner's concept knowledge for concepts in the set of concepts.

7. A non-transitory memory medium for tracing variation of concept knowledge of learners over time and evaluating content organization of learning resources used by the learners, wherein the memory medium stores program instructions, wherein the program instructions, when executed by a computer system, cause the computer system to implement:
performing a number of computational iterations until a termination condition is achieved, wherein each of the computational iterations includes a message passing process and a parameter estimation process,
wherein the message passing process includes computing a sequence of probability distributions representing time evolution of concept knowledge of the learners for a set of concepts based on (a) learner response data acquired over time, (b) state transition parameters modeling transitions in concept knowledge resulting from interaction with the learning resources, (c) question-related parameters characterizing difficulty of the questions and strengths of association between the questions and the concepts;
wherein the parameter estimation process computes an update for parameter data including the state transition parameters and the question-related parameters based on the sequence of probability distributions and the learner response data;
storing the sequence of probability distributions and the update for the parameter data in memory.

8. The memory medium of claim 7, wherein each question i of said questions has a corresponding set Sᵢ of one or more tags indicating one or more of the concepts that are associated with the question, wherein each learning resource m of said learning resources has a corresponding set Sₘ of one or more tags indicating one or more of the concepts that are associated with the learning resource m, wherein said parameter estimation process includes restricting support of the state transition parameters and support of said questions related parameters based on said tag sets Sᵢ and said tag sets Sₘ.

9. The memory medium of claim 7, wherein the learner response data comprises graded answers to questions posed to the learners over time.

10. The memory medium of claim 7, wherein the program instructions, when executed by the computer system, cause the computer system to further implement:
selecting a question from a set of questions by maximizing an expectation of a conditional probability p(c^{(t+1)}|c^{(t)},i) over the set of questions, wherein i is an index to the set of questions, wherein c^{(t)} represents concept knowledge at the current time instant, wherein c^{(t+1)} represents concept knowledge at a future time instant;
transmitting a message to the given learner indicating the selected question as a recommendation for further study.

11. A method for tracing variation of concept knowledge of learners over time and evaluating content organization of learning resources used by the learners, the method comprising:
performing a set of operations using a computer system, wherein the set of operations includes:
receiving current graded response data corresponding to a current time instant among a plurality of time instants, wherein the current graded response data represents one or more grades for one or more answers provided by one or more of the learners in response to one or more questions posed to the one or more learners from a universe of possible questions;
receiving current learner activity data corresponding to the current time instant, wherein, for each of the one or more learners, the current learner activity data identifies one or more learning resources, from a set of learning resources, used by the learner between the current time instant and a previous one of the time instants;
performing a number of computational iterations until a termination condition is achieved, wherein each of the computational iterations includes a message passing process and a parameter estimation process,
wherein the message passing process includes computing probability distributions, wherein, for each of the one or more learners and each of the time instants, a corresponding one of the probability distributions represents concept knowledge of the learner with respect to a set of concepts at the time instant, wherein said computing the probability distributions is based on input data comprising:
the current graded response data;
previously-accumulated graded response data corresponding to time instants prior to the current time instant;
the current learner activity data;
previously-accumulated learner activity data corresponding to transitions between successive pairs of the prior time instants;
for each of the one or more learning resources, state transition parameters that characterize a model of random transition of the concept knowledge as a result of learner interaction with the learning resource;
for each of the one or more questions, association parameters characterizing strengths of association between said question and concepts in the set of concepts;
wherein the parameter estimation process includes computing an update for parameter data including the state transition parameters and the association parameters based on the probability distributions, the current graded response data, the previously-accumulated graded response data, the current learner activity data and previously-accumulated learner activity data, wherein said computing the update includes optimizing an objective function over a multi-dimensional space corresponding to the state transition parameters and the association parameters;
after the termination condition has been achieved, storing the probability distributions, the state transition parameters and the association parameters in memory.

12. The method of claim 11, wherein the input data also includes, for each of the one or more questions, an estimated difficulty of the question.

13. The method of claim 11, wherein said optimizing the objective function includes independently optimizing a plurality of subspace objective functions over respective subspaces of the multi-dimensional space.

14. The method of claim 13, wherein the plurality of subspace objective functions includes a subspace objective function for each of the learning resources and a subspace objective function for each of the questions.

15. The method of claim 14, wherein the subspace objective function for learning resource m is a sum of terms Gₘ(t,j) over time-learner pairs (t,j) such that learner j interacted with learning resource m between time instant t−1 and time instant t, wherein the term Gₘ(t,j) is a sum of (a) an expectation of a negative log likelihood of concept knowledge of learner j at time instant t conditioned upon concept knowledge of learner j at time instant t−1 and the state transition parameters associated with the learning resource m and (b) a sparsifying term enforcing sparsity on at least a subset of the state transition parameters associated with the learning resource m.

16. The method of claim 14, wherein the sub-objective function for each question i is a sum of terms Hᵢ(t,j) over time-learner pairs (t,j) such that learner j answered question i at time instant t, wherein the term Hᵢ(t,j) is a sum of (a) an expectation of a negative log likelihood of a grade achieved by the learner j on question i at time t conditioned upon concept knowledge of the learner j at time t and the association parameters for question i.

17. The method of claim 11, wherein the state transition parameters for learning resource m is of the form c^{(t)}=(I+Dₘ)c^{(t-1)}+dₘ+ε^{(t-1)}, wherein vector c^{(t)} represents concept knowledge at time instant t, wherein c^{(t-1)} represents concept knowledge at time instant t+1, wherein the state transition parameters for learning resource m include matrix Dₘ, vector dₘ and matrix Γₘ, wherein matrix Γₘ is a covariance matrix characterizing zero-mean random noise vector ε^{(t-1)}.

18. The method of claim 17, wherein components of the vector dₘ represent effectiveness of the learning resource m for inducing changes in a corresponding one of the concepts, wherein the set of operations includes transmitting a message to an instructor or a learner or an author of the learning resource m, wherein the message includes the vector dₘ.

19. The method of claim 17, wherein the matrix Dₘ for learning resource m is constrained during said optimization to be sparse and lower triangular, wherein each non-zero element of the matrix Dₘ represents a corresponding prerequisite relationship between a corresponding pair of the concepts and a strength of the prerequisite relationship, wherein the set of operations includes displaying a graphical representation of the prerequisite relationships and their strengths based on the matrix Dₘ.

20. The method of claim 11, wherein the message passing process includes:
a forward subprocess that recursively computes, for each time index t=1, 2, . . . , T, an estimate for probability distribution p(c^{(t)}|y⁽¹⁾, . . . , y^{(t)}) based on probability distribution p(c^{(t-1)}|y⁽¹⁾, . . . , y^{(t-1)}), probability distribution p(c^{(t)}|c^{(t-1)}) and probability distribution p(y(t),c(t)), wherein c^{(t)} represents concept knowledge at time instant t, wherein c^{(t-1)} represents concept knowledge at time instant t−1, wherein y^{(u)} represents a grade for a given learner at time instant u, wherein T is the current time index; and
a backward subprocess that recursively computes, for each time index t=T, (T−1), (T−2), . . . , 2, 1, an estimate for probability distribution p(c^{(t-1)}|y⁽¹⁾, . . . , y^{(T)}) based on probability distribution p(c^{(t)}|y⁽¹⁾, . . . , y^{(T)}), probability distribution p(c^{(t)}|c^{(t-1)}) and probability distribution p(y(t),c(t)).
